(19) United States
(12) Patent Application Publication
(10) Pub. No.: US 2026/0155273 A1
(43) Pub. Date: Jun. 4, 2026

(54) METHOD OF HOMOLYTIC AND HETEROLYTIC CLEAVAGE IN MOLECULES OF GASES AND LIQUIDS

(71) Applicant: Dereroy & Co., a.s., Prague 4 (CZ)

(72) Inventor: Gennadiy CHERNOV, Prague 4 (CZ)

(21) Appl. No.: 18/881,188

(22) PCT Filed: Jun. 30, 2023
(86) PCT No.: PCT/IB2023/056845

§ 371 Date: Jan. 3, 2025

(30) Foreign Application Priority Data
Jul. 6, 2022 (CZ) CZ2022-301

(51) Int. Cl. G21G 5/00

(52) U.S. Cl. CPC G21G 5/00

(57) ABSTRACT

The method is for homolytic and heterolytic cleavage in molecules of gases and liquids with the release of bonding energy and its use to change the internal geometric architecture of some molecules, leading to the synthesis of new chemical compounds that are not contained in the initial gases and liquids, with the secondary release of energy during the synthesis process, without carrying out nuclear reactions on equipment for its realization, characterised by an increase in the energy of the work environment and use of this energy to generate thermal energy with simultaneous synthesis of new chemical compounds, in consequence of the physical effect of a standing pressure wave on the gas and liquid molecules at various temperatures, where the temperature is a measure of activation energy, and subsequent dissociation of the molecules into atoms or fragments of molecules (radicals), partial ionization of atoms and subsequent transformation of the bonds in atoms of the molecules with no change to atomic number but with a change to atomic mass and in the proton-neutron ratio. The method also consists in the direct conversion of neutron mass into the mass equivalent to the total mass of 1 electron and 1 proton that do not go beyond the framework of the electrodynamic interaction of electrons and the nucleus, which ensures the absence of radiation, where the method also consists in the transformation of an atom into a chemical molecule or the reverse transformation of 1 electron and 1 proton into 1 neutron from the volume, where these elementary particles can be free, with external exchange of energy and mass equalling the mass with a positive charge and equal to the reduction in the mass of the neutron and proton. The method furthermore consists in a back reaction to the physical effect consisting in the formation of new chemical compounds that are not contained in the initial gases and liquids, with the release of the energy produced during the process of recombination of atoms into the original molecules, where the execution of the proposed method takes place through a combination of initial influences, such as for example: 12 C 1 H 4=16 Ne=16 O, while the method further consists in rearranging the architecture of some molecules without changing the atomic number, mass number, atomic weight as a reaction to a physical impact, during which new chemical compounds are synthesized, including those that they are not contained in the initial gases and liquids, while the energy generated during these synthesis reactions is released, for example 14 N 2=12 C 16 O; 12 C 16 O 2=14 N 2 16 O. The proposed method is implemented by a combination of initial influences, such as:
increase in temperature of up to 250° C., ideally 140° C. to 150° C.;
reduction in pressure (creation of a reduced atmosphere) to-100 kPa, ideally-65 kPa;
generation of standing pressure waves;
electric discharge (tribostatic discharge, barrier, spark) with a breakdown voltage of 1 to 15 kV;
the value of the magnetic field in the reactor based on the discharge in the gas is 70 to 120 nTl;
micro-explosions;
impact, impact force, at which negative acceleration at from 50,000 to 150,000 g occurs;
or a combination of these influences.
The apparatus for converting hydrocarbon and non-hydrocarbon gases and liquids consists of
an acceleration module, which is a piece of apparatus accelerating a mixture of gas and liquid up to a speed of 30 to 400 m/s;
a deceleration module, which is a tribostatic energy generator covering 70% to 90% of the reactor's cross-section;
a tribostatic generator, which consists of two electrodes which are placed side by side an on which positive and negative charges are mutually created;
a reduced atmosphere zone after the deceleration module.

### TECHNICAL FIELD

The invention concerns a method for homolysis and heterolysis in molecular gases and liquids with the release of binding energy, its use for synthesizing new chemical compounds and generating thermal and microwave energy. It seeks to resolve problems with chemical synthesis and the generation of excess thermal energy in non-equilibrium weakly ionized cold plasma, in gases and liquids of varying composition in consequence of the release of binding energy in molecules and atoms, producing new chemical substances within the framework of the electrodynamic interaction of molecules and without nuclear reactions. The invention also covers the apparatus for realization of this method.

The invention can be used for:
use of gases produced during combustion processes;
production of products of organic synthesis;
production of green hydrogen;

### BACKGROUND ARTS

Methods and Apparatus for Generating Energy from Matter.

Ionization (cold plasma chemistry) is a known phenomenon in which the outer shells of electrons are ejected from atoms of oxygen, nitrogen, argon and other gases, and ions and other active participles are formed. Ionization requires a temperature of around 3000° C. and can be created by an electric pulse (Industrial Herald, 9, 1999, p. 19).

There is a known method for generating thermal energy based on nuclear reactions that occur when cavitation bubbles in water collapse. Cavitation bubbles are formed in the liquid as a result of periodically changing pressure in cavitation apparatus that is used as an “ultrasound activator”. When the bubbles “collapse”, the pressure difference causes their sides to speed up; they acquire kinetic energy and collide in the centre. The quantity of energy produced and concentrated in the microzone is sufficient to disrupt part of the bonds between atoms in molecules and nucleons in atoms and partially break them down into the elementary particles contained in the working material. The result is that a nuclear reaction occurs at the moment of collapse of the cavitation bubble, releasing a large quantity of thermal energy (RF U.S. Pat. No. 2,054,604, F 24 J 3/00. Bull. 5 of 20. 2. 1996). The released thermal energy has low potential, however, which limits the possibilities for practical use. In addition, the substance (working medium) has to be in liquid state.

There is a way to increase the energy of the working medium consisting in exposing the cavitation water to a catalyst, e.g. inert argon gas, which increases the water's sonoluminescence by a factor of three (M. A. Margulis. Sonochemical reactions and sonoluminescence-M.: Chemistry, 1986. p. 288.). The absolute energy level in this method is negligible, however.

There is a method for increasing the working medium's energy for motors and thermal power plants consisting in passing an electric pulse through the working medium, e.g. by means of a magnetic pole, laser beam or electric arc (British application no. 2241746, F 02 G 1/02. Edition no. 65, no. 5, 1993, p. 22).

There is known apparatus for modifying air in a combustion engine (ICE) designed to ozonize the air before it is mixed with the fuel, which increases the completeness of fuel combustion and reduces the toxicity of the engine's exhaust gases. The air is ozonized by moving the air towards an electron current generated by a corona discharge between two electrodes (USSR author certificate no. 1341366, F 02 M 27/00, Bull. No. 3 of 30. 9. 1987). The disadvantage is the complexity of the apparatus's construction and the need for a sufficiently powerful electric current generator

It is known that only oxygen molecules are dissociated into negative ions when air is exposed to electric or magnetic pulses. In this case dissociation of nitrogen molecules does not occur because the dissociation energy of nitrogen molecules is double the energy of oxygen (USSR author certificate no. 1825887, F 02 M 27/04, Bull no. 25 of 7. 7. 1993).

Apparatus exists for treating fuel components using catalysts that provides increased fuel combustion efficiency. The apparatus contains a sealed cylinder with a granulated catalyst (RF U.S. Pat. No. 1,799,429, F 02 M 27/00, Bull. No. 8 of 28. 2. 1993).

Methods and apparatus for converting natural gas (methane) into organic substances and hydrocarbon fuel.

Natural gas can be converted into liquid fuel using various known methods. These methods include, for example, the Fischer-Tropsch method and methods devised by the firm Mobil comprising multi-step process for converting gas into liquid using plasma. The Fischer-Tropsch method and processes devised by Mobil feature multi-step synthesis stages in which a light hydrocarbon (i.e. gaseous hydrocarbon) is first converted into synthesised gas at high pressure and temperatures up to 1300 K (1026.85° C.). The synthesized gas is a mixture of carbon monoxide (CO) and hydrogen (H₂). The synthesized gas is usually produced by burning a gaseous hydrocarbon without oxygen. The subsequent reactions are presented to illustrate examples of the aforesaid known methods:

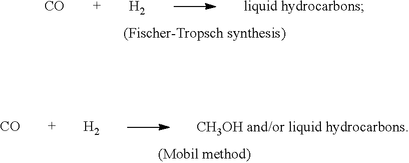

The extremely high temperature needed in the cracking unit means that gas synthesis requires a voluminous structure and is costly to operate. The GTL installation has to be large and complex to be commercially viable. The operating cost of the energy needed to compress and heat the gas is very high and makes up around 60% to 80% of the total cost of producing fuel by this method. In addition, generally expensive catalysts are used in all stages of the known conversion methods, and these often need replacing.

Another approach to converting light hydrocarbons into liquid fuel is to use a non-thermal plasma process.

Patent U.S. Pat. No. 7,033,551 describes a reactor system comprising electrochemical cells and using dielectric barrier discharge during which liquid products are formed, mainly by oligomerization of gaseous hydrocarbon radicals in non-thermal plasma during the barrier discharge in the gas. The non-thermal plasma ensures the initial concentration of free radicals as a result of the dissociation of light alkane molecules by high-energy electrons at a low gas temperature (from approximately 100° C. to approx. 600° C.) and low atmospheric pressure of the gas. In conjunction with the barrier discharge the electrochemical cells enable the oxygenation of the excess hydrogen in the plasma and incomplete oxygenation and oxidative condensation of the main gas. The final composition contains a mixture of liquid hydrocarbons, a minority of them alcohols. Shortcomings of this technical solution are the use of an external discharge source and the fact that the transformation processes in the barrier discharge reactor are not chain reactions, as well as the high activation energy of the main process of radical formation.

Patent U.S. Pat. No. 6,375,832 describes the synthesis of liquid products by means of a barrier discharge, where the use of a catalyst is optional. The synthesis method described in this patent gives rise to oligomers of hydrocarbon radicals as a result of the dissociation of the source gas and conversion of the hydrocarbons from fragments of free radicals, using direct synthesis and oxidative condensation. If CO₂ is added to the original mixture as an oxidizing agent, transformation of carbon dioxide also occurs, which aids the formation of liquid hydrocarbons. Shortcomings of this technical solution are the use of oxidizing agents and the external discharge source.

The following patents:
U.S. Pat. No. 8,203,027 B2-Continuous process and plant design for conversion of biogas to liquid fuel
RU (11) 2012 112 065 A-Non-fractionation method for production of low-boiling fuel from crude oil or fractions thereof;
US no. 2011/0049014 A1-Continuous process and plant design for conversion of biogas to liquid fuel;
US 2011/0000128A1-Process for conversion of biogas into liquid fuels;
U.S. Pat. No. 7,880,044 B2-Conversion of biogas into liquid fuels;
U.S. Pat. No. 8,226,817 B2-Non-fractionation process for producing low-boiling fuel from crude oil;

each describe a method and apparatus for improving the qualitative characteristics of automobile fuels and conversion of biogas and natural gas, where the concentration of methane must be at least 50% or 80%. The conversion of methane is achieved by passing a mixture of gaseous and oily liquids over a metal grid on which a voltage of indefinite (uncontrolled) frequency is spontaneously generated. The disadvantage of this technical solution is the low efficiency of the methane conversion, which dissipates to zero over time. There is a known method for producing C₂-C₃ hydrocarbons by means of high-temperature oxidative transformation of methane using a heterogeneous catalyst containing ions of alkali metal, manganese, wolfram and silica oxide (Pat. 2341507, RU-hereinafter referred to as “D3”). The transformation takes place at a catalyst temperature of 734-910° C., the C₂-C₃ selectivity reaches 87.6%, and methane conversion 20% (for C₂ hydrocarbons: ethylene and +ethane 81%). The shortcomings of this method are the use of high temperatures and the external discharge source.

There is a known method for transforming methane in electric discharge plasma [ShigeruKado, YasushiSekine, TomohiroNozaki, KenOkazaki/CatalysisToday 89, (2004), 47-55]. The following data on hydrocarbon formation selectivity in the barrier discharge are given: C₂˜39% (ethane ˜35%; ethylene ˜2.5%; acetylene ˜1.5%) and also C₃-C₅ hydrocarbons ˜32%, other ˜26% and carbonaceous sediments ˜3%. It is stated after comparison of corona, spark and barrier discharge that methane conversion is higher and the proportion of carbonaceous sediments lower in the case of barrier discharge. Shortcomings of this method are the low selectivity as regards ≥2+ hydrocarbons and carbon sediments detected in the external discharge source reactor.

U.S. Pat. No. 2,466,977RU describes a methane conversion method done with water at a flow of methane from 0.63 to 3.6 l/h′1 and water from 1.3 to 6 ml/h 1, fed into a reactor at a temperature from 25° C. to 120° C. and a reactor discharge time from 12 to 72 s. The use of an external discharge source is a shortcoming of this technical solution.

Other significant limitations of methods based on barrier discharge plasma are the low values of electric current (10-5-10-3 A/cm³) and the density of the released barrier discharge plasma energy (1-10 W/cm³), which reduce the reactor systems' productivity. In addition, the above methods based on the use of plasma only make it possible to regulate the temperature of the source gas.

At the current state of technology, methods for producing C₂+ hydrocarbons by conversion of methane in a reactor with one dielectric barrier by means of the barrier discharge plasma effect, but only in the conversion of methane, are closest to the proposed method.

Another known state-of-the-art technology is patent RU 2003132259 A, which is a method of heating a liquid by changing the physical and mechanical parameters of the liquid using cavitation, which can be further increased by introducing gases containing methane and oxygen into the liquid. This thermal energy is used in the liquid where cavitation processes take place to activate the synthesis processes of organic compounds of oxygen (alcohols) and higher hydrocarbons, which contain chemical compounds contained in the initial liquid and gas. This creates additional thermal energy that can be used to heat physical media in other processes. In the currently filed patent, the invention claims the use of various physical methods of action on liquids or gases that lead to a rearrangement of the architecture of certain molecules without changing the mass number or atomic weight, but sometimes with a change in atomic number, as a response to physical activity in which new chemical compounds are synthesized, including those not contained in the original gases and liquids, while the energy generated in these synthesis reactions is released (consumed).

Another state-of-the-art technology is WO 9729833 A1 (ABB RESEARCH LTD) 21/08/1997, which concerns a method of converting one of the greenhouse gases CO₂, N2O, in the presence of hydrogen-containing gases H2, H2S, CH4, on a solid catalyst, in the presence of a catalyst accelerating the reaction of N2 and N20 to a synthesis gas and then to a chemically or technically suitable substance. In the invention being submitted now, there is a claim to the invention of the use of various physical agents acting on liquids or gases, which lead to the rearrangement of the architecture of certain molecules without changing the mass number or atomic weight, sometimes the atomic number changes, as a response to physical activity, in which new chemical compounds are synthesized, including those not contained in the original gases and liquids, and releasing (consuming) the energy generated in these synthesis reactions, such as the conversion of CO2 into air components or the conversion of N2 into CO components and then into C and CO2 without using hydrogen-containing gases, e.g. according to the following model:

$$\begin{matrix} {CO}_{2} = {N}_{2} O 6 ; \\ 2 {N}_{2} O = 2 {N}_{2} + {O}_{2} 7 ; \\ {O}_{2} = {N}_{2} + 2 {H}_{2} 8 ;\end{matrix}$$

or the following model:

$$\begin{matrix} {N}_{2} = CO 9 ; \\ 2 CO = C + {CO}_{2} 10 ;\end{matrix}$$

unlike patent WO 9729833, in this filed application nitrogen is directly involved in greenhouse gas conversion processes.

Another state-of-the-art technology is the document entitled “T. V. Bonner and W. M. Brubaker: Nitrogen decay by neutrons”, for the reason that in the described solution the nitrogen atom decays under the influence of external neutrons in nuclear reactions:

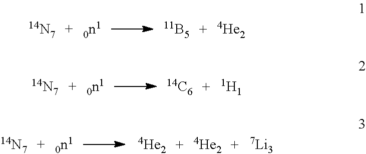

In the invention being submitted now, however, the nitrogen molecule is transformed into a new chemical compound that is not contained in the original gases and liquids, without gaining or losing protons and neutrons in the molecule, i.e. without nuclear reactions, e.g.:

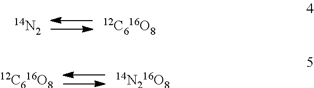

### DISCLOSURE OF INVENTION

The aforesaid shortcomings are eliminated by the method of homolytic and heterolytic cleavage in molecules of gases and liquids releasing binding energy, use of the energy for synthesizing new chemical compounds and generating thermal and microwave energy in line with this invention, the essence of which is increasing the energy of the working environment and using this energy to generate thermal energy while simultaneously synthesizing new chemical compounds, in consequence of the physical effect of a standing pressure wave on molecules of gases and liquids at various temperatures, where the temperature is a measure of activation energy, and the subsequent dissociation of the molecules into atoms or molecule fragments (radicals), partial ionization of the atoms and subsequent transformation of bonds in the atoms of molecules with no change to atomic number but with a changed atomic mass and different proton to neutron ratio. The method furthermore consists in the direct conversion of neutron matter into a mass equivalent to the total mass of 1 electron and 1 proton, which do not go beyond the framework of electrodynamic interaction of electrons and the nucleus, which ensures the absence of radiation. The method furthermore consists in the transformation of an atom into a chemical molecule or the reverse transformation of 1 electron and 1 proton into 1 neutron from the volume, where these elementary particles may be free, with the external exchange of energy and mass equalling the mass with a positive charge and equal to the loss of mass of the neutron and proton. It furthermore consists in a back reaction to a physical effect consisting in the formation of new chemical compounds that are not contained in the initial gases and liquids, releasing energy produced during the process of the recombination of atoms into the original molecules, where the execution of the proposed method takes place through a combination of initial influences, such as:
increase in temperature of up to 250° C., ideally 140° C. to 150° C.;
reduction in pressure (creation of a reduced atmosphere) to-100 kPa, ideally-65 kPa;
generation of standing pressure waves;
electric discharge (tribostatic discharge, barrier, spark) with a breakdown voltage of 1 to 15 kV
the value of the magnetic field in the reactor based on the discharge in the gas is 70 to 120 nTl;
micro-explosion;
impact, impact force, at which negative acceleration at from 50,000 to 150,000 g occurs;
or a combination of these influences.

The apparatus for converting hydrocarbon and non-hydrocarbon gases and liquids, which only makes use of the physical impact method, specifically standing pressure wave and tribostatic effect, and under which the gaseous component is fed into the reactor, consists of:
an acceleration module, which is a piece of apparatus accelerating a mixture of gas and liquid up to a speed of 30 to 400 m/s;
a deceleration module, which is a tribostatic energy generator covering 70% to 90% of the reactor's cross-section;
a tribostatic generator, which consists of two electrodes which are placed side by side an on which positive and negative charges are mutually created;
a reduced atmosphere zone after the deceleration module.

The following technical apparatus creates non-equilibrium cold plasma:
an acceleration module, in which the first impact processes occur and supersonic gas flows are formed;
a deceleration module, which slows down the gas flow and on whose electrodes tribostatic voltage and electric discharges are formed;
zone with reduced atmosphere after the deceleration module; the speed of the gas flow, and thus the intensity of processes in the deceleration module, depend on the value of its reduced pressure.

The apparatus is fitted with an input pipe for feeding in gases and an output pipe for extracting:
inorganic, organic, hydrocarbon liquids or mixtures thereof with modified composition;
non-hydrocarbon and hydrocarbon gases, or mixtures thereof with modified composition;
thermal energy, whose value gives an energy efficiency value greater than 1; in the apparatus, the surface level of the liquid component in the reactor is kept in close proximity to the acceleration module. The apparatus has a specific plasma energy ranging from 0.01 J/cm³ to 16 J/cm³. In the apparatus, the strength of the tribostatic electric field in the reactor based on gas discharge is lower than 14 kV/cm. In the apparatus, the value of the magnetic field in the reactor based on the discharge in the gas is 70 to 120 nTl.

The plasma components-electrons and positive ions—are formed in the inter-electrode space as a result of dissociation and ionization of gas and liquid molecules, i.e. in the process of separating electrons from a molecule or atom. The used mechanical and thermal energy converts into ionization energy. The ionization energy is smaller, the more electrically positive the element is, which means the lower it is in the group and the further to the left in the periodic table (minimum for alkali metals, maximum for rare gases). Ionization causes the substance to fragment.

As soon as they are released, the binding electrons of atoms start to function as generators of further energy. The direct discharge breaks down into fragments that convert into ball lightning due to the minimum surface energy principle, giving rise to non-equilibrium cold plasma. When the gas/liquid mixture is abruptly decelerated, a reverse sound wave is formed, which moves towards the source of the direct wave and, under its influence, back to the deceleration zone, where a sudden release of pressure occurs, the molecule “explodes” and breaks down into atoms, fragments or even nucleons, with a pronounced dynamic impact on its neighbours. The exchange of impulses of two identical molecules of gas and liquid with one-off interaction causes them to expand at a particular speed for achieving the same interaction with other molecules. The same occurs when a molecule of the gaseous or liquid working substance comes into contact with the solid substance of the catalyst in the deceleration module.

When the working substance molecule interacts with the catalyst molecule, first it is influenced by its attractive force; subsequently also by the forces of other catalyst molecules as a result of dynamic electromagnetic interaction, which significantly increases the dynamic acceleration of the working substance molecule towards the deceleration module and catalyst. Unlike the gas molecule, the molecule of the solid catalyst only vibrates and does not rotate. Consequently, the gas molecule moving towards the catalyst does not encounter the repulsive force of an opposite-charge field.

The electrostatic field stabilises the gas molecule's movement towards the target catalyst: as in any electrodynamic interaction, the gas molecule stops its rotation and takes the shortest route. All that contributes to its accelerated movement towards the target, an increased impact load upon impact and the destruction of the molecule itself. In this case the neighbouring molecules of the working substance do not interfere with the process and do not prevent the molecule's acceleration, because at that moment they are interacting with other molecules.

The attractive force increases in inverse proportion to the square of the distance and in proportion to the product of the opposite charges of the interacting bodies. If we consider that the speed of movement of molecules during interaction ranges from 30 to 400 m/s, when they approach the deceleration module the speed rapidly increases by many multiples, which leads to a collision and the immediate attenuation of the speed.

This highly pronounced non-linearity is very similar to the energy change curve of a cavitation bubble in a liquid. In both cases the energy, proportional to the square of the speed, accumulates gradually and is then suddenly released in a very short time. It is evident that the low reaction speed causes great reaction strength thanks to the high speed of the effect that is capable of destroying a molecule of the substance.

Naturally, the recombination of atoms, and in particular nucleons, into reaction products in the presence of the catalyst has a lower activation barrier than the recombination of molecules, which ensures that the reaction does not take place without the catalyst, which also accelerates it, and also rules out increased energy intensiveness in the reaction zone. The molecule deceleration mechanism ultimately results in the breakdown of molecules of the working substance and interaction of their smaller parts-atoms, fragments and even nucleons—while reaction products are formed without a chain reaction being initiated.

The proposed method and apparatus for implementing the method are based on experimental data and data from alternative atomic and molecular spectroscopy. The fundamental law of A. M. Butlerov's structure theory says that “the chemical nature of a complex particle is determined by the nature of its elementary components, their number and chemical structure. . . Substances containing the same elementary components and in the same quantity differ because the dependence of the movement between atoms of these parts is broken down differently in different cases . . . ”

The advantage of this invention is that it represents a universal method in which exposing molecules of liquids and gases to an external influence in the form a shock wave at low temperatures at a given volume results in the dissociation of molecules and ionization of atoms and recombination of the bonds in these molecules, releasing excess energy which is used for chemical synthesis reactions.

Physico-Chemical Processes of the Invention

(Processes are Demonstrated by Reactions 1 to 38 in Table 1)

The method implements the following physico-chemical principles:
1. External physical factors cause any gaseous or liquid substance, including natural and renewable carbon dioxide, air, water etc., to be broken down into the atoms that form a molecule.
2. A shortage-excess of energy and mass of the reaction products disappears-regenerates in natural conditions based on energy-mass, mass-energy exchange processes with a quantum vacuum, which reduces the consumption of the initial substances.
3. The quantity of energy generated by the bonds destruction-recombination process by means of plasma electrons changes the geometric structure of the bonds (length, angle) in atoms of the original molecule, giving rise to a new chemical element. The primary electron donors are any gases.
4. At the same time as substances in catalyst volume are decomposed and synthesized, there is a release of excess thermal energy, which is converted into electrical energy, with the efficiency coefficient at the level of existing industrial equipment, and fed back into the process, which increases the processes' energy efficiency for commercial use in industrial processes.

### For Example

A molecule of nitrogen N₂, total atomic number 14, atomic weight 28, is transformed:
with symmetrical decomposition:
   into two atoms of nitrogen N, total atomic number 14, atomic weight 28, with possible recombination into a nitrogen molecule, or;
   into two CH₂ radicals, total atomic number 16, atomic weight 28, or;
   one CH₂ radical and one atom of hydrogen H2 and one atom of carbon C, total atomic number of fragments and new elements 16, atomic weight 28; or
   two atoms of carbon 2C and four atoms of hydrogen 4H, total atomic number of products 16, atomic weight 28, or;
an atom of carbon C and a molecule of methane CH₄, total atomic number of products 16, atomic weight 28;
with asymmetrical decomposition:
   into an atom of oxygen O and an atom of carbon C, total atomic number 14, atomic weight 28, and;
   into a molecule of carbon monoxide CO in a reaction between the atom of carbon C and the atom of oxygen O, total atomic number 14, atomic weight 28, or;
in parallel processes of symmetrical and asymmetrical decomposition of nitrogen molecules:
possible synthesis of:
   molecules of water H₂O and;
   molecules of oxygen O₂ and;
   molecules of CO2 in a combustion reaction between carbon C and molecular oxygen O₂ and into a molecule of CO2 and a molecule of water H₂O in a reaction between methane CH₄ and two molecules of molecular oxygen O₂, and;
   molecules of organic molecules and hydrocarbons in polycondensation reactions and synthesis of the following products:
   Aldehydes;
   Ketones;
   Alcohol;
   Simple and complex ethers;
   Fatty acids;
   Alcohols of fatty acids;
   Hydrocarbon gases;
   Hydrocarbon liquids:

### For Example

A molecule of oxygen O₂, total atomic number 16, atomic weight 32, is transformed:
with symmetrical decomposition:
   into two atoms of oxygen O, total atomic number 16, atomic weight 32, and;
   into two atoms of nitrogen N (molecule of N₂) and four atoms of hydrogen (2H₂), total atomic number 18, atomic weight 32, and;
   into two CH₂ radicals and two molecules of hydrogen, total atomic number 20, atomic weight 32, or;
   one CH₂ radical and three molecules of hydrogen H₂ and an atom of carbon C, total atomic number 20, atomic weight 32, or;
   two atoms of carbon 2C and eight atoms of hydrogen 8H, total atomic number 20, atomic weight 32, or;
   two molecules of methane CH₄, total atomic number 20, atomic weight 32;
with asymmetrical decomposition:
   into a molecule of nitric oxide NO and two atoms of hydrogen, total atomic number 17, atomic weight 32, or;
   into a molecule of nitrogen and four atoms of hydrogen, total atomic number 18, atomic weight 32, and;
   two CH₂ radicals and 4 atoms of hydrogen, total atomic number 20, atomic weight 32, or
   one CH₂ radical and three molecules of hydrogen H₂ and an atom of carbon C, total atomic number 20, atomic weight 32, or;
   two atoms of carbon 2C and eight atoms of hydrogen 8H, total atomic number 20, atomic weight 32, or;
   two molecules of methane CH₄, total atomic number 20, atomic weight 32;
in parallel processes of symmetrical and asymmetrical decomposition of oxygen molecules, the following synthesis is possible:
   molecules of water H₂O and;
   molecules of oxygen O₂ and;
   molecules of CO2 in a combustion reaction between carbon C and molecular oxygen O₂, and molecules of CO2 and molecules of water H₂O in a reaction between methane CH₄ and two molecules of molecular oxygen O₂, and;
   molecules of organic molecules and hydrocarbons in polycondensation reactions and synthesis of the following products:
      Aldehydes;
      Ketones;
      Alcohol;
      Simple and complex ethers;
      Fatty acids;
      Alcohols of fatty acids;
      Hydrocarbon gases;
      Hydrocarbon liquids:

In processes in which carbon and hydrocarbon liquids and gases are formed, a defect (deficit) in the weight of the product occurs. When hydrocarbon gases and liquids decompose, matter is converted into energy.

Under this method, molecules of other hydrocarbon gases, including toxic ones, can be exposed to decomposition, for example
N₂O and other oxides of nitrogen;
H₂S;
SO₂
fluorides;

### For Example

A molecule of methane CH₄ with a total atomic number of 10 and atomic weight of 16 will change the geometry of its bonds and acquire new properties or transform into another chemical element:
into an atom of oxygen O, atomic number 8, atomic weight 16;
two molecules of methane, total atomic number 20, atomic weight 32, into an oxygen molecule, total atomic number 16, atomic weight 32;
into an atom of nitrogen and an atom of hydrogen, total atomic number 9, atomic weight 16;
two molecules of methane, total atomic number 20, atomic weight 32, into two molecules of nitrogen and two molecules of hydrogen, total atomic number 18, atomic weight 32;
When the geometric configuration of bonds between nucleons and electrons changes, a defect (surplus) of the product weight occurs. The surplus weight occurs by conversion of a proton+an electron+energy into a neutron. The quantity of the product will therefore be greater than the used input materials, as observed in the tests. The mechanism for forming neutrons from a proton-electron pair is caused by an external change in the strength of a magnetic field (increase) and synchronization of the magnetic poles of the proton and electron in the neutron space. The electron and proton in the methane molecule rotate with opposite magnetic poles, during which the electron transitions to a lower level in the space of the emerging neutron, with photon emission.

The proposed method addresses the problem of processing industrial greenhouse gases CO2, CH₄, water vapour, N₂O, O₃ (ozone).

### For Example

Depending on the energy of the external influence, a molecule of carbon dioxide CO2, total atomic number 22, atomic weight 44:
dissociates according to formulae 24 and 25;

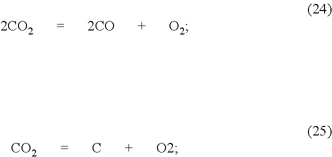

In reactions 24 and 25 the total sum of the products' atomic weights is 88 or 44 respectively. Continuation of reaction 16 is possible up to:

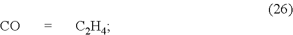

atomic weight of the CO is 29, the atomic weight of C₂H₄ is 28. In view of the decomposition and transformation of the oxygen molecule the final reaction 16 is:

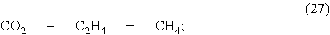

the atomic weight of CO₂ is 44, the atomic weight of C₂H₄ is 28, the atomic weight of CH₄ is 16, the total atomic number of the products is 44.

### For Example

Depending on the energy of the external influence, a molecule of nitrous oxide N₂O, total atomic number 22, atomic weight 44:
dissociates according to formulae 28 and 29;

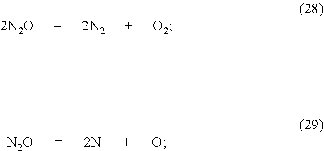

In reactions 28 and 29 the products' total atomic weight is 88 or 44 respectively. Reactions 20, 21 can continue with reactions 1 to 23.

### For Example

Depending on the energy of the external influence, a molecule of water H₂O, total atomic number 10, atomic weight 18:
dissociates according to formulae 30 and 31:

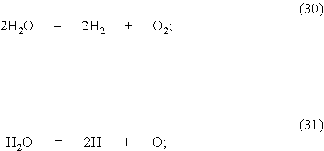

In reactions 30 and 31 the products' total atomic weight is 36 or 18 respectively. Reactions 30, 31 can continue with reactions 1 to 23.

### For Example

Depending on the energy of the external influence, a molecule of ozone O₃, total atomic number 24, atomic weight 48:
dissociates according to formulae 32 and 33:

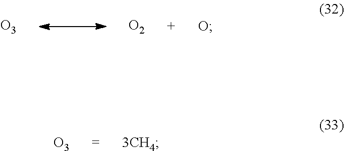

In reactions 32 and 33 the products' total atomic weight is 48. Reactions 32, 33 can continue with reactions 1 to 23.

### For Example

Depending on the energy of the external influence, a molecule of chlorine Cl₂, total atomic number 34, total atomic weight 68:
dissociates according to formulae 34 and 35:

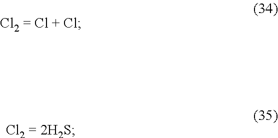

In reactions 34 and 35 the products' total atomic weight is 68. Continuation of reaction 35 is determined by the formula

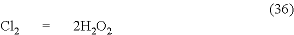

In reaction 36 the products' total atomic weight is 68. Continuation of reaction 36 is determined by the formula

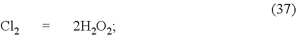

In reaction 37 the products' total atomic weight is 68.

Reaction 37 can continue with reactions 1 to 23.

The mechanisms of reactions with CO, COCl₂, NO, H₂S gases are explained above. The proposed method addresses the problem of processing toxic gases Cl₂, CO, COCl₂ (phosgene), NO (nitric oxide), H₂S (hydrogen sulphide).

### BRIEF DESCRIPTION OF DRAWINGS

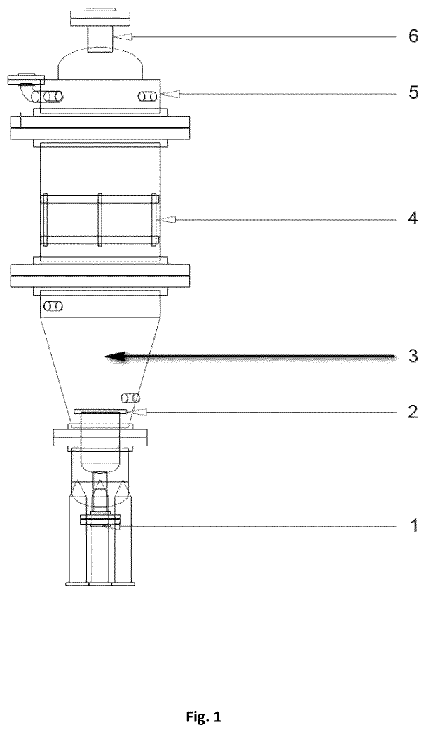

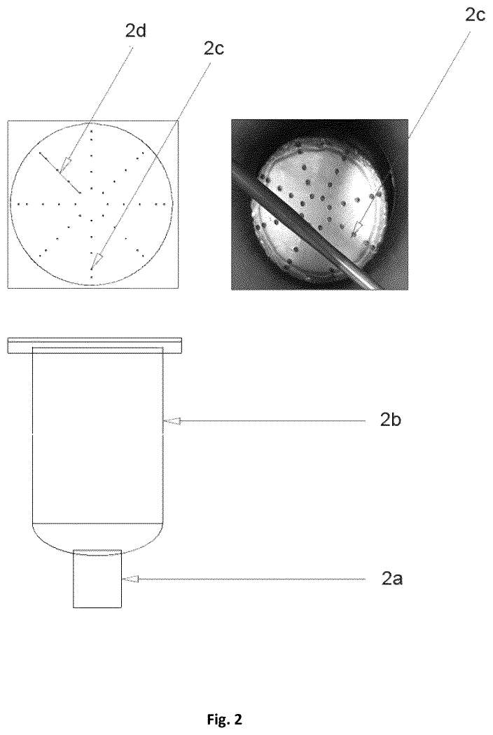

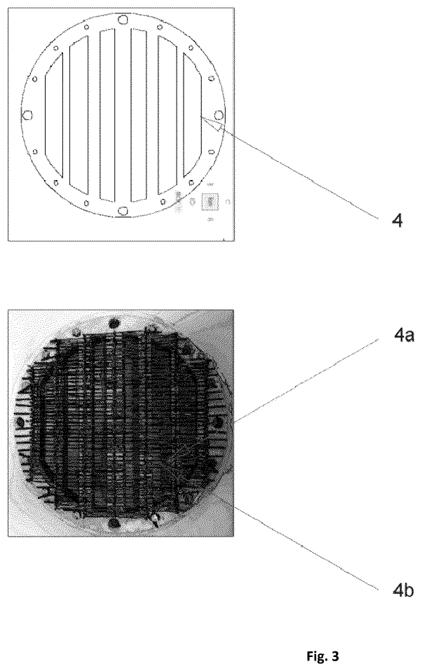

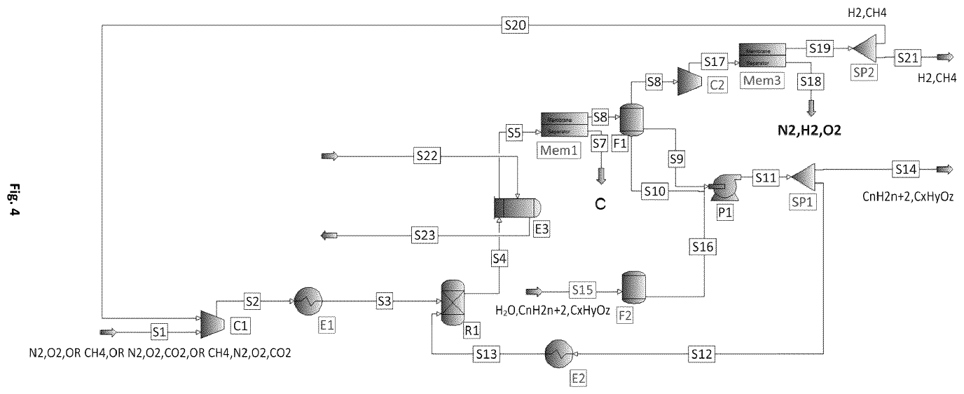

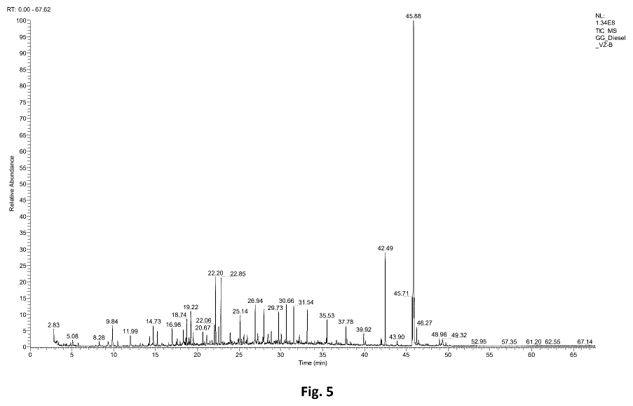

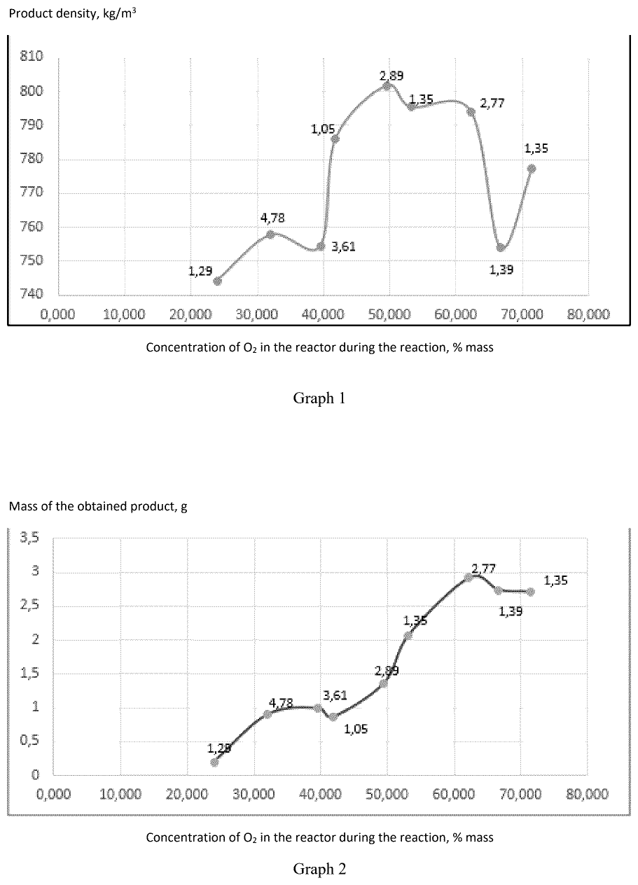

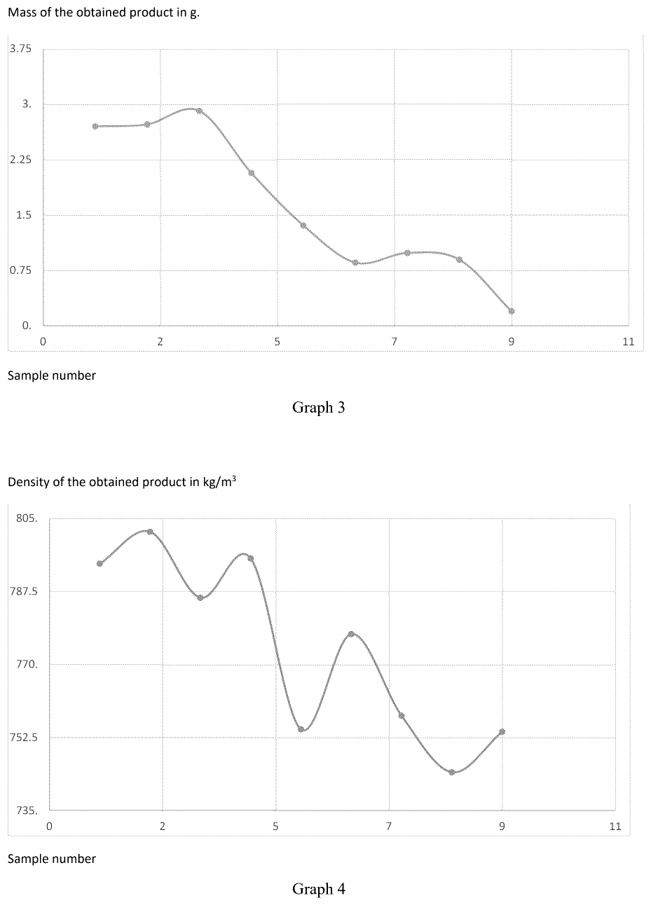

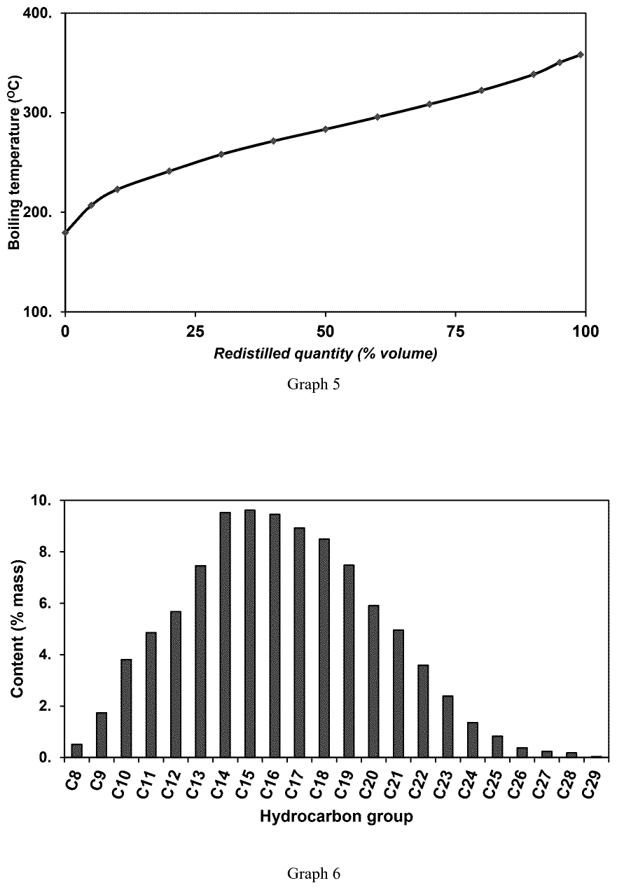

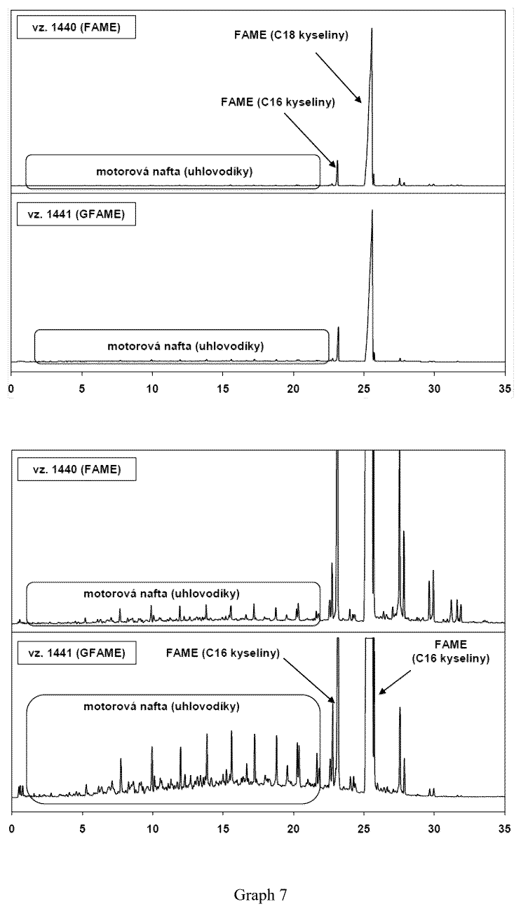

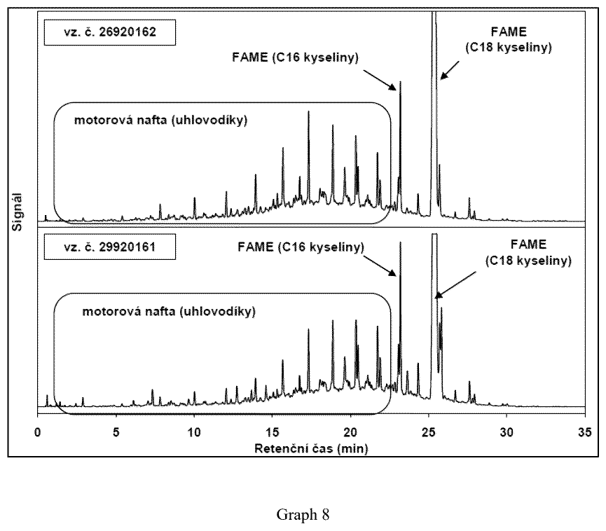

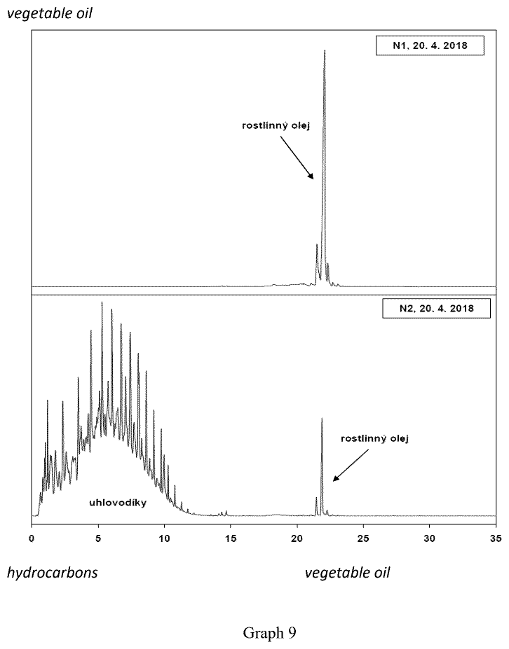

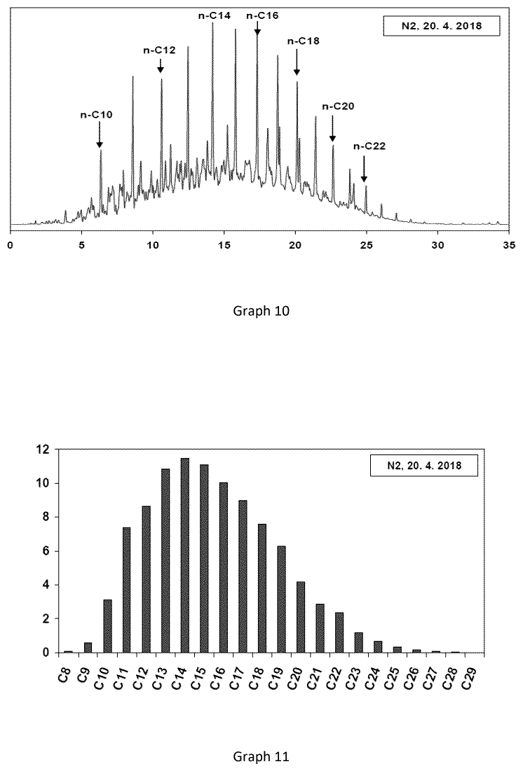

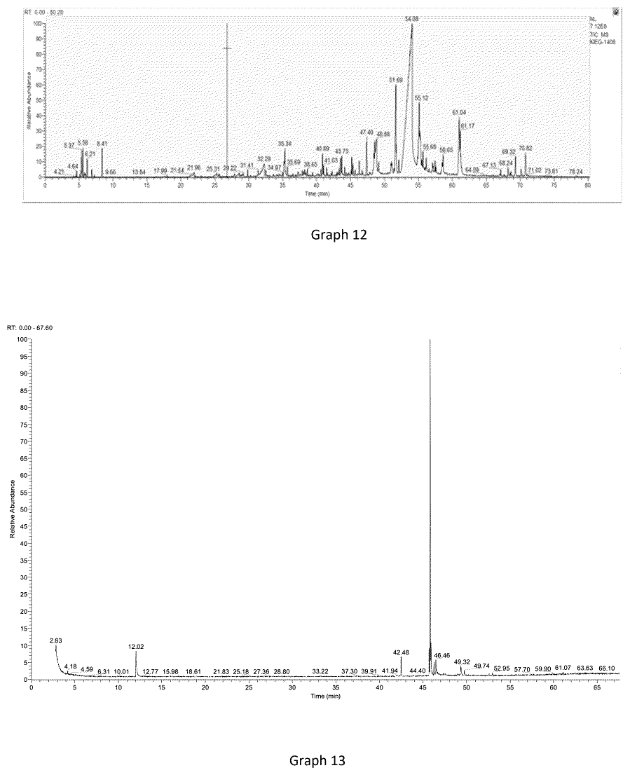

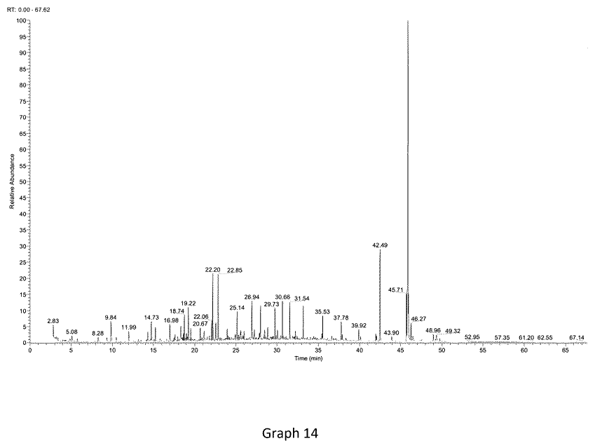

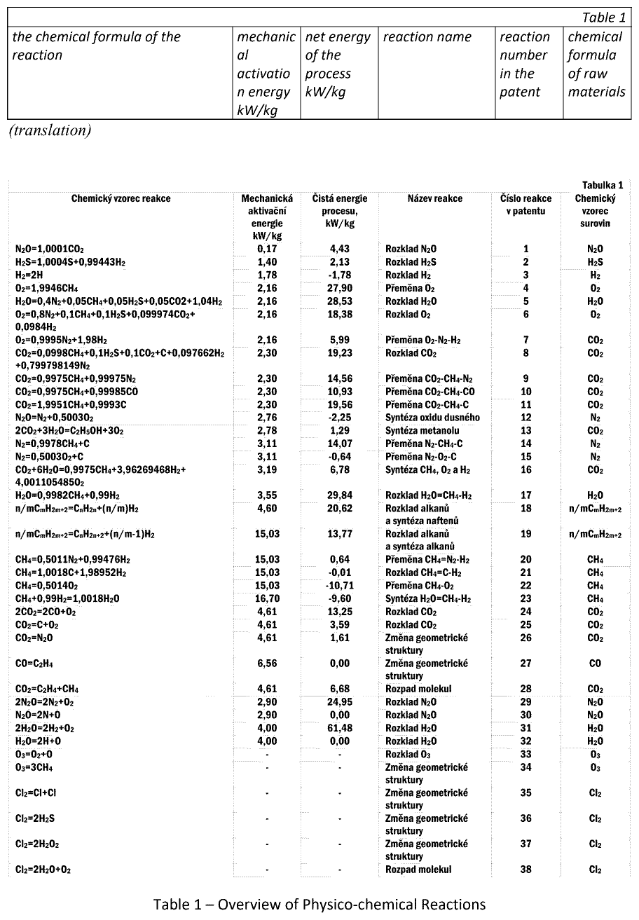

A diagram will be used to explain the invention, in which FIG. 1 shows the structure of the apparatus; FIG. 2 the acceleration module; FIG. 3 the deceleration module; FIG. 4 the general flow chart for the declared method according to the invention; and Table 1 gives an overview of the reactions of chemical elements. Figure. 5 shows an analysis of the product in the reactor boiler R1 of the three-phase separator F1.

Graph 1 shows the dependence of the density of the generated products on the duration of gas action as it travels from the acceleration module to the deceleration module and the tribostatic generator. Graph 2 shows the dependence of the weight of the manufactured products on the duration of gas action from the acceleration module to the deceleration module and the tribostatic generator. Graph 3 shows the dependence of the weight of the formed products on the physico-chemical properties of the gas from the acceleration module to the deceleration module and the tribostatic generator. Graph 4 shows the dependence of the density of the generated products on the physico-chemical properties of the gas from the acceleration module to the deceleration module and the tribostatic generator. Graph 5 shows the complete results of the standard distillation test (ČSN EN ISO 3405) in the form of a distillation curve. Graph 6 shows the determination of the distribution of individual hydrocarbon groups according to the number of carbon atoms using gas chromatography. Graph 7 shows the results of gas chromatography used in Example No. 6. Graph 8 shows the results of gas chromatography used in Example No. 7. Graph 9 shows the analysis of raw materials and products from the separator used in Example No. 8. Graph 10 shows a more detailed chromatographic analysis of the sample “N_{2, 20/04/2018}”. Graph 11 shows the distribution of hydrocarbons in the sample “N_{2, 20/04/2018}”. Graph 12 is a representation of the chromatogram of the analysis of sample “14. 8. 18” (nitrogen, no recycling). Graph 13 shows the chromatographic record for sample 3GTL-(060620181), A, Jun. 6, 2018/1. Graph 14 shows the chromatographic record for sample 3GTL-(060620182), A, Jun. 6, 2018/2.

Table 1 is an overview of all physicochemical reactions.

### MADE FOR CARRYING OUT THE INVENTION

A mixture of gases from an external source and recycling apparatus is fed though pipe 1 into the gaseous mixture input connected to acceleration module 2 and passes through the pipe to enter interior space 3 of the reactor.

Acceleration module 2 is a piece of apparatus for accelerating the gas mixture to supersonic speeds of over 5 Ma. The hypersonic impact tube contains pipes 2a connected in series, receiving chamber 2b, acceleration module 2 and hypersonic nozzles whose output leads into interior space 3 of the reactor. The hypersonic nozzles are made in the form of numerous Laval nozzles 2c, which are designed to form beam 2d. The number of 2c nozzles and the number of 2d beams ensure the passage of the gas or liquid.

Pipes 2a and high-pressure chamber 2b of acceleration module 2 are fitted with a pressure sensor. There is also a pressure sensor installed in interior space 3 of the reactor.
The sensors are connected to a data logging computer.

The hypersonic impact tube works as follows:
pipe 2a and high-pressure chamber 2b of acceleration module 2 are filled with a mixture of the input gas. A standing pressure wave is initiated in a simple manner—by increasing the pressure in pipe 2a and high-pressure chamber 2b. The standing pressure wave passes through a conical channel to the hypersonic Laval nozzles 2c. Part of the wave reflects off the ingress to the hypersonic nozzles 2c; the other part passes through the hypersonic nozzles 2c and the high-speed flow passes from hypersonic nozzle 2c into interior space 3 of the reactor and then into deceleration module 4.

The input flow accelerates to speeds over 5 Ma. The range of speeds determines the change in the composition of the gas medium in the reactor. Acceleration module 2 is immersed in various liquids, whose covalent bonds decompose, releasing electrons. The speed of the mixture is determined by its pressures at the inlet and outlet of acceleration module 2.

The gas and liquid mixture discharges into interior space 3 of the reactor with an acceleration of 50,000 to 150,000 g, which is decelerated by deceleration module 4. Gas molecules start to dissociate upon contact with the moving generated standing pressure wave. The through-flow differs from one specific gas to another in terms of its own chemical properties. The capacity of the material of deceleration module 4 used as a catalyst in these reactions plays a role in the calculation of surface heating, which means that the hypersonic flow becomes dependent on the chemical properties of the moving gas. The lower limit of the mode is determined by the first component of the gas which starts to dissociate at a given stagnation temperature of the flow, which is 2000 K in the case of nitrogen. The upper limit of this mode is determined by the onset of ionization of gas atoms in the gas flow. In this case the number of electrons released from atoms becomes significant. The temperature of the electron gas is deemed to be isolated from the other gas components. This mode corresponds to the gas flow speeds range of 10 to 12 km/s (>25 Ma) and the state of the gas in this case is described using non-radiation plasma models.

Acceleration module 2 ensures the dissociation of input gas molecules, which is confirmed by a significant pressure increase in the reactor and reduction in the molecular mass of gas in the reactor. For example, when air is already in the reactor and more is fed in, the molecular mass in the reactor's geometric volume falls from 28.2 to 19 g/mol, which confirms the dissociation and partial ionization of molecules of nitrogen and oxygen. Deceleration module 4 is located no further than 1 m away from acceleration module 2, which ensures the maximum energy of the gas flow (gas and liquid mixture). Deceleration module 4 simultaneously fulfils the function of a tribostatic voltage generator in consequence of friction processes on electrodes 4a and 4b, on which electrostatic voltage increases. This electrostatic voltage leads to decomposition in the space between electrodes 4a and 4b and the occurrence of discharges. Electrodes 4a and 4b are situated on a metal base, which ensures that electrodes 4a and 4b are immobile when they collide with the gas and liquid flow. Electrodes 4a and 4b are insulated from the metal base. When the voltage between electrodes 4a and 4b is monitored, a constant 1 to 10 V level, with a frequency of 0.3 to 1 Hz, is registered.

The following elements are suitable materials to choose for electrodes 4a and 4b: Fe, Co, Ni, Chr, Gd, W, Al, Ti and their alloys containing C, Cu, Hf, Pd, Os, Pt. The distance between electrodes 4a and 4b ranges from 1 to 10 mm.

The volume of zone 5 ensures regulation of the pressure after deceleration module 4 for controlling the speed of the flow of gas and liquid through the Laval nozzles 2c.

The choice of material for electrodes 4a and 4b is determined by a calculation of the maximum surface emission of electrons and positive ions from solid surfaces adjoining the gas. Electrons are emitted when the surface is bombarded with electrons whose kinetic energy is greater than the metal's work function. In this case, emission of a secondary electron is possible in addition to the rebound off the surface of the primary electron.

The acceleration block shown in FIG. 2 can be immersed in one of the liquids on the recommended list.

The gas or mixed gas and liquid flow leaves the acceleration module at a speed of from 30 to 400 m/s. The gas and liquid molecules reach the reaction space in a short time.

The data given in the examples was obtained from various tests implementing the invention process in a pilot plant, FIG. 1. The physical nature of the processes occurring in the examples is presented in detail in the patent section titled Operation of the Apparatus and Physical Principles of its Functioning.

Depending on how the apparatus is used-described below—the gaseous mixture containing gases or mixtures thereof is fed into the apparatus's gas inlet and passes through the acceleration block with acceleration module 2 and catalyst, which simultaneously fulfils the role of:
deceleration module 4 and tribostatic electricity generator, FIG. 3. The channel's cross-section is 60% to 90% blocked by metal electrodes 4a and 4b. As the gas or gas and liquid mixture passes the electrodes it decelerates sharply. The result is that micro-explosions, impacts and electric barrier discharges occur in the reaction space.

When the gas or gas and liquid mixture comes into contact with a non-thermal pulsed sliding discharge, micro-explosions or impact zones, the atoms reconfigure and combine into the following types of gases and liquids, depending on the energy released:
air;
nitrogen;
carbon monoxide;
carbon dioxide;
oxygen;
hydrogen;
hydrocarbon gases;
inert gas;
oxides of nitrogen;
or mixtures thereof;
vegetable oils;
mineral oils;
esters;
diesel;
mazut;
gas oil;
diesel;
methyl esters (FAME);
paraffin;
gasoline;
alcohols;
water;
or mixtures thereof;

The conversion of gases and liquids in the reaction chamber can reach as much as 90% and is regulated by changing the output of gas compressor C₁ in the reactor inlet connected to acceleration module 2. Reaction gases and initial gases and liquids travel from the gas flow outlet towards cooling, separation and membrane separation.

### Example 1

Formation of Methane Molecules from Oxygen Molecules.

Preparatory phase. Air is forced out with the target gas.

Reactor R1 with acceleration and catalytic module, which fulfils the functions of:
deceleration module;
tribostatic voltage generator

Atmospheric air fills the reactor's interior volume. The concentrations of nitrogen and oxygen in atmospheric air by mass are 76.37% and 23.225% respectively. The ratio between the relative numbers of nitrogen molecules to oxygen molecules is 3.288. A pressure cylinder of technical nitrogen is connected to gas mixture inlet 1. The nitrogen and oxygen content in the pressure cylinder is 94.25% and 5.747% respectively. The analysis was performed by laboratories of ALS Czech Republic, s.r.o. Nitrogen, flow S1, is fed into the reactor inlet from the pressure cylinder. The composition of sample 1 in the cylinder is as follows:

| | | Unit of | | |
|---|---|---|---|---|
| Parameter | Value | measurement | Method | Accreditation |
| Methane | <0.003 | % volume | CSN EN ISO 6976, CSN EN | SA |
| | | | 27941, CSN EN ISO 6974-3,4 | |
| Oxygen | 5.06 | % volume | CSN EN ISO 6976, CSN EN | SA |
| | | | 27941, CSN EN ISO 6974-3,4 | |
| Nitrogen | 94.8 | % volume | CSN EN ISO 6976, CSN EN | SA |
| | | | 27941, CSN EN ISO 6974-3,4 | |
| Carbon monoxide | <0.003 | % volume | CSN EN ISO 6976, CSN EN | SA |
| | | | 27941, CSN EN ISO 6974-3,4 | |
| Hydrogen | <0.003 | % volume | CSN EN ISO 6976, CSN EN | SA |
| sulphide | | | 27941, CSN EN ISO 6974-3,4 | |
| Methane | 0.000 | % mass | | |
| Oxygen | 5.75 | % mass | | |
| Nitrogen | 94.25 | % mass | | |
| Carbon monoxide | <0.003 | % mass | | |
| Hydrogen | <0.003 | % mass | | |
| sulphide | | | | |

The volume of gas in the reactor is 0.279 m³. The initial mass of nitrogen in the reactor is 0.2581 kg. The initial mass of oxygen in the reactor is 0.0785 kg. Overpressure 0 Pa.

Gas of the given composition is fed via stream S1 from the gas cylinder into the reactor inlet at a flow rate of 120 to 130 g/min. The specific energy supplied by the gas stream is 25 J/cm³. Overpressure of 3447.5 Pa is constantly maintained in the reactor. The average temperature of the reactor when the gas is being fed in is 13° C.

494.27 grams of gas was fed in and 514 grams of gas was simultaneously discharged through the outlet in the reactor. The analysis of the gas after it was fed into the installation was performed by laboratories of ALS Czech Republic, s.r.o. The composition of the gas in the reactor after gas was fed in is:

| | | Unit of | | Accred- |
|---|---|---|---|---|
| Parameter | Value | measurement | Method | itation |
| Methane | 2.4 | % volume | CSN EN ISO 6976, | SA |
| | | | CSN EN 27941, | |
| | | | CSN EN ISO 6974-3,4 | |
| Oxygen | 1.09 | % volume | CSN EN ISO 6976, | SA |
| | | | CSN EN 27941, | |
| | | | CSN EN ISO 6974-3,4 | |
| Nitrogen | 95.5 | % volume | CSN EN ISO 6976, | SA |
| | | | CSN EN 27941, | |
| | | | CSN EN ISO 6974-3,4 | |
| Carbon | 0.1 | % volume | CSN EN ISO 6976, | SA |
| monoxide | | | CSN EN 27941, | |
| | | | CSN EN ISO 6974-3,4 | |
| Hydrogen | 0.0006 | % volume | CSN EN ISO 6976, | SA |
| sulphide | | | CSN EN 27941, | |
| | | | CSN EN ISO 6974-3,4 | |
| Methane | 1.4 | % mass | | |
| Oxygen | 1.24 | % mass | | |
| Nitrogen | 97.33 | % mass | | |

A theoretical calculation of the quantity of nitrogen and oxygen after gas was fed from the gas cylinder into the reactor, which initially contained air, shows that in the absence of any reaction in the reactor the concentration by mass of nitrogen and oxygen should be 93.225% and 6.775% respectively, with a ratio of 13.263 between the relative numbers of nitrogen molecules and oxygen molecules.

The concentration of molecular nitrogen, methane, carbon monoxide and hydrogen sulphide increased in consequence of the decrease in the concentration of oxygen and the participation of nitrogen molecules in reactions as follows:

| | | Concentration of gas | Concentration of gas | Relative % change |
|---|---|---|---|---|
| | Unit of | in the reactor before | in the reactor after | in the gas |
| Parameter | measurement | nitrogen was fed in | nitrogen was fed in | composition |
| Methane | % volume | 0.000 | 1.38 | 137,900.000 |
| Oxygen | % volume | 23.250 | 2.189 | −90.584 |
| Nitrogen | % volume | 76.370 | 96.323 | 26.126 |
| Carbon | % volume | 0.001 | 0.1008 | 9980.000 |
| monoxide | | | | |

See Table 1-Overview of Physico-chemical Reactions for reactions 5, 7, 13, 15 and 16 described in the method for which patent protection is being sought.

### Material Balance:

During the process, the concentration of oxygen by mass decreased by 4.48% and the concentration of methane and nitrogen by mass increased by 4.48%.

### Example 2

Formation of Nitrogen and Oxygen Molecules from Methane with Recycling

Preparatory phase. Air is forced out with the target gas.

Reactor R1 with acceleration module 2 and catalytic module, which fulfils the functions of:
deceleration module;
tribostatic voltage generator

The reactor and separator are open in the test preparatory phase.

Atmospheric air fills the reactor's internal volume. The concentrations of nitrogen and oxygen in atmospheric air by mass are 76.37% and 23.225% respectively. The ratio between the relative numbers of nitrogen molecules and oxygen molecules is 3.288. A pressure cylinder containing methane NG, flow S1, with a flow rate of 110 to 130 g/min. is connected to the gas mixture inlet. The analysis of the gas in the installation is as follows:

| | | Unit of | | |
|---|---|---|---|---|
| Parameter | Value | measurement | Method | Accreditation |
| Methane | 98.78 | % volume | ISO 6974-3.4 | SA |
| Oxygen | 0.17 | % volume | ISO 6974-3.4 | SA |
| Nitrogen | 0.62 | % volume | ISO 6974-3.4 | SA |
| Carbon | 0.00 | % volume | ISO 6974-3.4 | SA |
| monoxide | | | | |
| Hydrogen | 0.00 | % volume | ISO 6974-3.4 | SA |
| sulphide | | | | |
| Hydrogen | 0.34 | % volume | ISO 6974-3.4 | SA |
| C2 | 0.02 | % volume | ISO 6974-3.4 | SA |
| C2= | 0.00 | % volume | ISO 6974-3.4 | SA |
| C3 | 0.03 | % volume | ISO 6974-3.4 | SA |
| C3= | 0.00 | % volume | ISO 6974-3.4 | SA |
| C4 | 0.02 | % volume | ISO 6974-3.4 | SA |
| C4= | 0.00 | % volume | ISO 6974-3.4 | SA |
| C5 | 0.00 | % volume | ISO 6974-3.4 | SA |
| C5+ | 0.01 | % volume | ISO 6974-3.4 | SA |

A liquid sorbent-naphtha—was fed into the reactor, with the surface level above acceleration module 2.

Recycling of gas from three-phase separator F1 is used with the help of gas ventilator C2, with the gas returned to the inlet to reactor R1.

The liquid sorbent in the boiler of reactor R1 is heated to 146° C. Blower C2 is activated. The gas mixture from separator F1 is conveyed into gas ventilator C2 and returns into the acceleration module 2, by recycled stream S20. The gas and liquid mixture is discharged from acceleration module 2 at a speed of from 30 to 400 m/s into the reactor space, where it comes into contact with a catalyst that fulfils the functions of:
deceleration module;
tribostatic voltage generator 4a, 4b;

The mixture's speed is regulated by the volume of gas fed into the acceleration module 2. After leaving the reaction space, the gas and liquid mixture is cooled in in the heat exchanger E3 and enters three-phase separator F1.

In the separator F1 the gas is separated from the liquid and enters the gas pump inlet. The cycle of the gas mixture's passage between the inlet and outlet of gas ventilator C2 is repeated. Analysis of the recycled gas:

| | | Unit of | | |
|---|---|---|---|---|
| Parameter | Value | measurement | Method | Accreditation |
| Methane | 82.19 | % volume | ISO 6974-3.4 | SA |
| Oxygen | 0.94 | % volume | ISO 6974-3.4 | SA |
| Nitrogen | 13.55 | % volume | ISO 6974-3.4 | SA |
| Carbon | 0.01 | % volume | ISO 6974-3.4 | SA |
| monoxide | | | | |
| Hydrogen | 0.00 | % volume | ISO 6974-3.4 | SA |
| sulphide | | | | |
| Hydrogen | 2.17 | % volume | ISO 6974-3.4 | SA |
| C2 | 0.21 | % volume | ISO 6974-3.4 | SA |
| C2= | 0.03 | % volume | ISO 6974-3.4 | SA |
| C3 | 0.29 | % volume | ISO 6974-3.4 | SA |
| C3= | 0.01 | % volume | ISO 6974-3.4 | SA |
| C4 | 0.29 | % volume | ISO 6974-3.4 | SA |
| C4= | 0.00 | % volume | ISO 6974-3.4 | SA |
| C5 | 0.13 | % volume | ISO 6974-3.4 | SA |
| C5+ | 0.18 | % volume | ISO 6974-3.4 | SA |

Analysis of the balance of input materials and reaction products makes it possible to draw the following conclusion:
The concentration of molecular nitrogen and oxygen increases in consequence of the decrease in the methane concentration:

| | | | | | Relative |
|---|---|---|---|---|---|
| | | | | Difference | percentage |
| | Unit of | At start of | At end of | as a result | difference |
| Parameter | measurement | process | process | of process | in mass |
| Methane | kg | 0.707 | 0.589 | −0.118 | −16.690 |
| Oxygen | kg | 0.002 | 0.013 | 0.011 | 550.000 |
| Nitrogen | kg | 0.008 | 0.169 | 0.161 | 2012.500 |
| Carbon | kg | 0.000 | 0.000 | 0.000 | — |
| monoxide | | | | | |
| Hydrogen | kg | 0.000 | 0.000 | 0.000 | — |
| sulphide | | | | | |
| Hydrogen | kg | 0.000 | 0.002 | 0.002 | — |
| C2 | kg | 0.000 | 0.003 | 0.003 | — |
| C2= | kg | 0.000 | 0.000 | 0.000 | — |
| C3 | kg | 0.001 | 0.006 | 0.005 | 500.000 |
| C3= | kg | 0.000 | 0.000 | 0.000 | — |
| C4 | kg | 0.001 | 0.008 | 0.007 | 700.000 |
| C4= | kg | 0.000 | 0.000 | 0.000 | — |
| C5 | kg | 0.000 | 0.004 | 0.004 | — |
| C5+ | kg | 0.000 | 0.007 | 0.007 | — |
| Total | kg | 0.720 | 0.801 | 0.081 | |

There is a total 11.3% excess based on reactions 20, 21, 22 and 23 in the patented method; see Table 1-Overview of Physico-chemical Reactions.

### Example 3

Formation of Hydrocarbon Liquid from Air in a Partial Recycling Process.

Reactor R1 with acceleration module 2 and catalytic module, which fulfils the functions of:
deceleration module 4;
tribostatic voltage generator 4a, 4b;.

The internal volume of reactor R1 equals 0.136 m³. Separator F1 is open. There is no coagulator in the separator. The initial temperature in the reactor is 10° C. Final temperature 102° C.

The accuracy class of the apparatus measuring the through-flow of input and output gas is 0.25. The quantity of gas that passed through the flow meter was checked by reweighing the gas cylinder on digital scales. The relative error of flow measurement is 0.25%.

Gas ventilator C2 extracts air from the upper part of the separator, which is connected to the atmosphere, and sends it to the inlet of reactor R1 and then into the acceleration module. On leaving reactor R1 the product was cooled by water heat exchanger E3 and the liquid phase of the product condensed in three-phase separator F1. Part of the gas passed from separator F1 to ventilator C2 in the form of a thin mist and condensed in the pressure pipe.

Process preparation parameters:
1. Input material: air and air vapours and synthesized organic liquids.
2. Internal volume of the reactor: 0.136 m³.
3. Pressure at inlet of ventilator C2: 0 kPa.
4. Overpressure in the reactor: 55 to 58 kPa.
5. Rate of gas flow from C2: (38 to 40 m³/h).
6. Volume of catalytic space: 0.0129 m³.
7. Speed of gas flow in front of catalytic panels: 330 m/s.
8. Current electricity consumption of gas ventilator C2: 3.04 KW/h.
9. The efficiency of the motor of gas ventilator C2 is 0.6.
10. The efficiency of gas ventilator C2 is 0.85.
11. Current energy on the shaft of gas ventilator C2 is 1.55 KW/h.
12. Total quantity of electricity consumed by gas ventilator C2 during the process: 17.94 kW/h.
13. Total quantity of energy on the shaft of gas ventilator C2 consumed by the process: 9.145 KW/h.
14. Range of temperature change of the liquid in the circuit in E3 in heating mode: 14 to 17 degrees Celsius.
15. Range of temperature change of the liquid in the circuit in E3 in cooling mode: 17 to 14 degrees Celsius.
16. Thermal capacity of the coolant in cooling circuit E3: 3.8 KJ×C⁻¹.
17. Mass of coolant in cooling circuit E3: 115 kg.
18. Temperature of coolant at inlet to cooler E3: 14 to 18 degrees C.
19. Temperature of coolant at outlet from water cooler E3: 14 to 18 degrees C.
20. Current flow of coolant through water cooler E3: 3,500 kg/h.
21. Actual value of thermal energy allocated to water cooler E3: 5.76 kW/h.
22. Total quantity of thermal energy allocated to water cooler E3: 33.98 KW/h.
23. The mass of the obtained product is 100 g.
24. The product's density is 858 kg/m³ at 25° C.; kinematic viscosity at 40° C. je 13.2 mm²/s.
25. Freezing point of the product:−11.2° C.
26. Physical energy efficiency-ratio between released thermal energy after the process and total consumed energy (thermal, mechanical), factoring in the efficiency of energy sources: 3.71. Energy balance of the process:

Balance of the process's current input
physical and output thermal energy

| | Unit of | Parameter |
|---|---|---|
| Parameter | measurement | value |
| Energy input | | |
| Input energy consumed by the process | kW/h | 1.55 |
| Total electricity consumption | kW/h | 1.55 |
| Thermal energy output | | |
| Current thermal energy output from | kW/h | 5.76 |
| post-reaction stream from reactor | | |
| Total thermal energy output from | kW/h | 5.76 |
| post-reaction stream from reactor | | |

Analysis of the balance of input materials and reaction products makes it possible to draw the following conclusion:

### Synthesis of the Hydrocarbon Product is Caused:

1. By the breakdown of nitrogen and oxygen molecules, followed by synthesis of these molecules and the release of excess energy.
2. If there is sufficient excess energy when air molecules are broken down in the catalytic zone, reaction 1 air->water commences, releasing energy of 12.2 MJ/kg of air.
3. If there is sufficient excess energy in the catalytic zone during reaction 1, reaction 2 air->methane in the water and air environment commences, releasing energy of 24.7 MJ/kg of air.
4. If there is sufficient energy in the catalytic zone during reaction 2, direct conversion of methane into normal alkanes and hydrogen begins as reaction 3.
5. If there is sufficient methane at a particular point in the catalytic space at a particular point in time, a reaction takes place, releasing energy of 150.7 KJ/mol, and then synthesis of a normal alkane is possible: n=1+Eₛₑ/9; Eₛₑ=kcal/mol; thus n=1+ (150,7/4,166)/9; n=5, so 1 mole of pentane C₅H₁₂ and 4 moles of hydrogen are formed from 5 moles of methane in accordance with synthesis of normal alkane with the given length of the hydrocarbon chain.
6. To a lesser degree and in the event of insufficient energy, the synthesis of alkanes followed by synthesis of ethers in the presence of oxygen is possible, as is the synthesis of alcohols from alkanes.
7. If a hydrocarbon with the formula CₘH₂ₘ₊₂ gradually accumulates in the pressure pipe of the gas ventilator C2, then after a certain time some part of the recycled gas will enter the acceleration module, making reaction 4 possible in the reaction block.

The concentration of molecular methane increases in consequence of the decrease in the nitrogen and oxygen concentration and reactions 15, 16, 24 and 25.

See Table 1-Overview of Physico-chemical Reactions for details of all the reactions.

### Example 4

Conversion of Methane into Hydrocarbons.

Reactor with acceleration module and catalytic module, which fulfils the functions of:
deceleration module 4;
tribostatic voltage generator 4a, 4b;
Recycling is not used. Preparatory phase. Air is forced out with the target gas.

Atmospheric air fills the reactor's internal volume. The concentrations of nitrogen and oxygen in atmospheric air by mass are 76.37% and 23.225% respectively. The ratio between the relative numbers of nitrogen molecules and oxygen molecules is 3.288. A pressure cylinder containing methane NG, stream S1, is connected to the gas mixture inlet.

Process preparation parameters:
1. Atmospheric pressure 97,990 Pa.
2. After the apparatus is closed, at the given atmospheric pressure there are 325 grams of air in it, molecular mass 28.98 g/mol, including 248 g of nitrogen (76.3% by mass) and 75 grams of oxygen (23.07% by mass).
3. 1^{st} feed of methane from the gas cylinder, quantity 22.57 g. The rate of flow S1 of the supplied gas is 0.7 m³/h; Overpressure in the apparatus after the gas is fed in is 12.41 kPa. The average temperature in the apparatus when methane is fed in is 15° C. Methane is fed in for 2.53 minutes.
4. 1^{st} output of reaction gases: the valve to let gas out of the reactor is opened until the overpressure value is 0 kPa. 20.53 grams of gas is extracted. The average temperature in the installation when the gas leaves is 15° C.
5. 2.7 grams of liquid phase is discharged from the reactor. Captured in a test-tube and numbered 1. The product's density is 794.12 kg/m³ at 22.8° C.
6. 2^{nd} feed of methane from the gas cylinder, quantity 23.23 g. The rate of flow S1 of the supplied gas is 0.7 m³/h; Overpressure in the apparatus after the gas is fed in is 13.79 kPa. The average temperature in the apparatus when methane is fed in is 15.5° C. Methane is fed in for 2.61 minutes.
7. 2^{nd} output of reaction gases: the valve to let gas out of the reactor is opened until the overpressure value is 0 kPa. 21.393 grams of gas is extracted. The average temperature in the installation when the gas leaves is 16° C.
8. 2.726 grams of liquid phase is discharged from the reactor. Captured in a test-tube and numbered 2. The product's density is 801.76 kg/m³ at 22.8° C.
9. 3^{rd} feed of methane from the gas cylinder, quantity 46.15 g. The rate of flow S1 of the supplied gas is 0.7 m³/h; Overpressure in the apparatus after the gas is fed in is 26.2 kPa. The average temperature in the apparatus when methane is fed in is 16.5° C. Methane is fed in for 5.18 minutes.
10. 3^{rd} output of reaction gases: the valve to let gas out of the reactor is opened until the overpressure value is 12.62 kPa. 41.99 grams of gas is extracted. The average temperature in the installation when the gas leaves is 16.5° C.
11. 2.908 grams of liquid phase is discharged from the reactor. Captured in a test-tube and numbered 3. The product's density is 785.95 kg/m³ at 22.8° C.
12. 4^{th} feed of methane from the gas cylinder, quantity 22.55 g. The rate of flow S1 of the supplied gas is 0.7 m³/h; Overpressure in the apparatus after the gas is fed in is 26.41 kPa. The average temperature in the apparatus when methane is fed in is 17° C. Methane is fed in for 2.53 minutes.
13. 4^{th} output of reaction gases: the valve to let gas out of the reactor is opened until the overpressure value is 11.86 kPa. 20.52 grams of gas is extracted. The average temperature in the installation when the gas leaves is 17° C.
14. 2.068 grams of liquid phase is discharged from the reactor. Captured in a test-tube and numbered 4. The product's density is 795.38 kg/m³ at 22.8° C.
15. 5^{th} feed of methane from the gas cylinder, quantity 48.13 g. The rate of flow S1 of the supplied gas is 0.7 m³/h; Overpressure in the apparatus after the gas is fed in is 39.99 kPa. The average temperature in the apparatus when methane is fed in is 17.5° C. Methane is fed in for 5.4 minutes.
16. 5^{th} output of reaction gases: the valve to let gas out of the reactor is opened until the overpressure value is 25.09 kPa. 43.80 grams of gas is extracted. The average temperature in the installation when the gas leaves is 17.5° C.
17. 1.358 grams of liquid phase is discharged from the reactor. Captured in a test-tube and numbered 5. The product's density is 754.44 kg/m³ at 22.8° C.
18. 6^{th} feed of methane from the gas cylinder, quantity 17.5 g. The rate of flow S1 of the supplied gas is 0.7 m³/h; Overpressure in the apparatus after the gas is fed in is 40.68 kPa. The average temperature in the apparatus when methane is fed in is 18° C. Methane is fed in for 1.97 minutes.
19. 6^{th} output of reaction gases: the valve to let gas out of the reactor is opened until the overpressure value is 21.37 kPa. 15.93 grams of gas is extracted. The average temperature in the installation when the gas leaves is 18° C.
20. 0.855 grams of liquid phase is discharged from the reactor. Captured in a test-tube and numbered 6. The product's density is 777.27 kg/m³ at 22.8° C.
21. 7^{th} feed of methane from the gas cylinder, quantity 60.12 g. The rate of flow S1 of the supplied gas is 0.7 m³/h; Overpressure in the apparatus after the gas is fed in is 55.44 kPa. The average temperature in the apparatus when methane is fed in is 18.7° C. Methane is fed in for 6.75 minutes.
22. 7^{th} output of reaction gases: the valve to let gas out of the reactor is opened until the overpressure value is 24.82 kPa. 54.71 grams of gas is extracted. The average temperature in the installation when the gas leaves is 18.7° C.
23. 0.985 grams of liquid phase is discharged from the reactor. Captured in a test-tube and numbered 7. The product's density is 757.69 kg/m³ at 22.8° C.
24. 8^{th} feed of methane from the gas cylinder, quantity 79.7 g. The rate of flow S1 of the supplied gas is 0.7 m³/h; Overpressure in the apparatus after the gas is fed in is 68.95 kPa. The average temperature in the apparatus when methane is fed in is 19° C. Methane is fed in for 8.96 minutes.
25. 8^{th} output of reaction gases: the valve to let gas out of the reactor is opened until the overpressure value is 0 kPa. 72.53 grams of gas is discharged. The average temperature in the installation when the gas leaves is 19° C.
26. 0.893 grams of liquid phase is discharged from the reactor. Captured in a test-tube and numbered 8. The product's density is 744.17 kg/m³ at 22.8° C.
27. 9^{th} feed of methane from the gas cylinder, quantity 21.55 g. The rate of flow S1 of the supplied gas is 0.7 m³/h; Overpressure in the apparatus after the gas is fed in is 12.41 kPa. The average temperature in the apparatus when methane is fed in is 19.2° C. Methane is fed in for 2.42 minutes.
28. 9^{th} output of reaction gases: the valve to let gas out of the reactor is opened until the overpressure value is 0 kPa. 19.61 grams of gas is extracted. The average temperature in the installation when the gas leaves is 19.2° C.
29. 0.196 grams of liquid phase is discharged from the reactor. Captured in a test-tube and numbered 9. The product's density is 753.85 kg/m³ at 22.8° C.

Graph 1 shows the dependency of the obtained products' density on the time of the gas's movement from the acceleration module to the deceleration module and tribostatic generator

The following table gives the results of the sample number, the duration of the gas feed, the density of the resulting product and the quantity of the obtained product:

| Sample number | 1 | 2 | 3 | 4 | 5 | 6 | 7 | 8 | 9 |
|---|---|---|---|---|---|---|---|---|---|
| Duration of gas feed in minutes | 2.53 | 2.61 | 5.18 | 2.53 | 5.4 | 1.97 | 6.75 | 8.96 | 2.42 |
| Product density, kg/m³ | 794.12 | 801.76 | 785.95 | 795.38 | 754.44 | 777.27 | 757.69 | 744.17 | 753.85 |
| Mass of obtained product, g | 2.7 | 2.726 | 2.908 | 2.068 | 1.358 | 0.855 | 0.985 | 0.893 | 0.196 |

Graph 2 shows the dependency of the obtained products' mass on the time of the gas's movement from the acceleration module to the deceleration module and tribostatic generator:
Graph 3 shows the dependency of the obtained products' mass on the physico-chemical properties of the gas from the acceleration module to the deceleration module and tribostatic generator:
Graph 4 shows the dependency of the obtained products' density on the physico-chemical properties of the gas from the acceleration module to the deceleration module and tribostatic generator:

Analysis of Example 4 and the liquid products makes it possible to draw the following conclusion:

### Synthesis of the Hydrocarbon Product in the Time Sequence is Caused:

1. By the breakdown of nitrogen and oxygen molecules, followed by synthesis of these molecules and the release of excess energy.
2. If there is sufficient excess energy in the catalytic zone during the breakdown of air molecules, reaction 16 air->methane commences, releasing 24.7 MJ per kg of air.
3. The higher the concentration of nitrogen and oxygen in the reactor, the more energy is generated and the more liquid with greater density is produced-reaction 24.

The concentration of molecular nitrogen and the obtained energy increase in consequence of the decrease in the concentration of nitrogen and oxygen present after the apparatus is depressurized and in consequence of the processes described in reactions 5, 7, 13, 14, 15, 16 and 17 and the formation of n-alkanes from methane after reaction 24. These processes are covered by the patent being applied for

See Table 1-Overview of Physico-chemical Reactions for details of all the reactions.

### Example 5

Conversion of Methane into Hydrocarbons in a Recycling Process

Reactor with acceleration module and catalytic module, which fulfils the functions of:
deceleration module;
tribostatic voltage generator

Preparatory phase. Air is forced out with the target gas.

Atmospheric air fills the reactor's internal volume. The concentrations of nitrogen and oxygen in atmospheric air by mass are 76.37% and 23.225% respectively. The ratio between the relative numbers of nitrogen molecules and oxygen molecules is 3.288. A pressure cylinder containing methane NG is connected to the gas mixture inlet.

1. Atmospheric pressure 97,990 Pa.

2. After the apparatus is closed, at the given atmospheric pressure there are 325 grams of air in it, molecular mass 28.98 g/mol, including 248 g of nitrogen (76.3% by mass) and 75 grams of oxygen (23.07% by mass).
3. 1^{st} feed of methane from the gas cylinder, quantity 134.3 g. The rate of flow S1 of the supplied gas is 0.7 m³/h; Overpressure in the apparatus after the gas is fed in is 68.95 kPa. The average temperature in the apparatus when methane is fed in is −2° C.
4. 1^{st} output of reaction gases: the valve to let gas out of the reactor is opened until the overpressure value is 0 kPa. 90.69 grams of gas is extracted. The average temperature in the installation when the gas leaves is −2° C.
5. 2^{nd} feed of methane from the gas cylinder, quantity 124.5 g. The rate of flow S1 of the supplied gas is 0.7 m³/h; Overpressure in the apparatus after the gas is fed in is 68.95 kPa. The average temperature in the apparatus when methane is fed in is −1.5° C.
6. 2^{nd} output of reaction gases: the valve to let gas out of the reactor is opened until the overpressure value is 6.895 kPa. 132.42 grams of gas is extracted. The average temperature in the installation when the gas leaves is −1.6° C.
7. 3^{rd} feed of methane from the gas cylinder, quantity 35.7 g. The rate of flow S1 of the supplied gas is 0.7 m³/h; Overpressure in the apparatus after the gas is fed in is 26.20 kPa. The average temperature in the apparatus when methane is fed in is −1° C.
8. 4^{th} feed of methane from the gas cylinder, quantity 34.1 g. The rate of flow S1 of the supplied gas is 0.7 m³/h; Overpressure in the apparatus after the gas is fed in is 48.06 kPa. The average temperature in the apparatus when methane is fed in is −1° C. Concentration of gases in the apparatus: nitrogen 36.41% by mass; oxygen 11.07% by mass; methane 52.52% by mass.
9. The heating of the reactor's gas space is activated.

Recycling of gas from separator F1 is used with the help of gas ventilator C2, with the gas fed back into the reactor.
10. Gas ventilator C2 is switched on. At a temperature of 87.5° C. in the reactor, 27 g of methane is fed in from the gas cylinder; the gas's rate of flow of S1 is 0.7 m³/h; overpressure in the reactor after the gas is fed in is 68.95 kPa.
11. The reactor is in operation for 1 hour 25 minutes. Initial electricity consumption by gas ventilator C2 is 2.02 KW/h; final consumption is 1.87 KW/h. Temperature in the reactor: initial 87.5° C., final 79.19° C. Overpressure 65.019 kPa. Gas ventilator performance: initial 130.07 m³/h, final 115.68 m³/h.
12. 160 grams of product with a density of 836.7 kg/m³ at a temperature of 15° C. is obtained.

### Analysis of the Product.

Gas chromatography analysis was performed, and selected parameters of one supplied sample of diesel labelled “13. 12. 2017” were specified; Example 5.

The gas chromatography analysis reveals that the sample is diesel with the usual distribution of hydrocarbons containing 2.5% FAME (bio-component). The complete results of a standard distillation test (CSN EN ISO 3405) are shown in Graph 5 in the form of distillation curves.

Gas chromatography was used to determine the distribution of individual hydrocarbon groups by number of carbon atoms-shown in Graph 6:

The cumulative values of the same determination are given in the following table:

| Hydrocarbon group | Content |
|---|---|
| (number of carbon atoms) | (% mass) |
| up to C8 | 0.5 |
| up to C9 | 2.3 |
| up to C10 | 6.1 |
| up to C11 | 10.9 |
| up to C12 | 16.6 |
| up to C13 | 24.1 |
| up to C14 | 33.6 |
| up to C15 | 43.2 |
| up to C16 | 52.7 |
| up to C17 | 61.6 |
| up to C18 | 70.1 |
| up to C19 | 77.6 |
| up to C20 | 83.5 |
| up to C21 | 88.5 |
| up to C22 | 92.0 |
| up to C23 | 94.4 |
| up to C24 | 95.8 |
| up to C25 | 96.6 |
| up to C26 | 97.0 |
| up to C27 | 97.2 |
| up to C28 | 97.4 |
| up to C29 | 97.5 |
| FAME | 2.5 |

The results of the determination of other physico-chemical properties of the analysed sample are presented in the following table, along with the requirements of EU standard EN 590 for diesels. It reveals that sample “13. 12. 2017” does not satisfy EN 590 solely in terms of sulphur content. If we overlook this shortcoming, the analysed fuel is usable in the Czech Republic only as grade B diesel (for the summer period from 15. 4. to 30. 9.) and grade D (for the transition period from 1. 10. to 15. 11, and from 1. 3. to 14. 4.), not as grade F winter diesel (from 16. 11. to 29. 2.)

| | Sample GGGTL | EN 590 |
|---|---|---|
| Parameter | 13 Dec. 2017 | requirement |
| Density at 15° C. | 836.7 | 820-845 |
| Kinematic viscosity at 40° C. | 3.15 | 2.00-4.5o |
| Distillation recovered at 250° C. | 25.0 | max. 65 |
| (% volume) | | |
| Distillation recovered at 350° C. | 95.0 | min. 85 |
| (% volume) | | |
| 95% recovery by volume at (° C.) | 250 | max. 360 |
| Cetane index | 55.7 | min. 46 |
| Flash point -PM (° C.) | 69.5 | min. 55 |
| Mono-aromatics content (% mass) | 13.5 | — |
| Poly-aromatics content (% mass) | 1.8 | max. 8 |
| Total aromatics content (% mass) | 15.3 | — |
| FAME content (% volume) | 2.4 | max. 7 |
| Sulphur content mg · kg⁻¹ | 14 | max. 10 |
| Filterability -CFPP (° C.) | −12 | max. 0/−10/−20 |

Analysis of Example 5 and the reaction products makes it possible to draw the following conclusion:

### Synthesis of the Hydrocarbon Product-Diesel—is Caused:

1. By the breakdown of nitrogen and oxygen molecules, followed by synthesis of these molecules and the release of excess energy.
2. If there is sufficient excess energy in the catalytic zone during the breakdown of air molecules, reaction 16 air->methane commences, releasing 24.7 MJ per kg of air.
3. The higher the concentration of nitrogen and oxygen in the reactor, the more energy is generated and the more liquid with greater density is produced by reaction 24.
4. The presence of methyl esthers (FAME) in the product is explained by the restructuring of radicals arising in plasma with synthesis of chemical substances containing oxygen.

The concentration of molecular methane and the generated energy increase in consequence of the decrease in the concentration of nitrogen and oxygen present after the apparatus is depressurized and in consequence of the processes described in reactions 5, 7, 13, 14, 15 and 16. The main synthesis of hydrocarbons takes place from methane according to reaction 24. These processes come under the patent being applied for

See Table 1-Overview of Physico-chemical Reactions for details of all the reactions.

### Example 6

Conversion of Methyl Esters into Hydrocarbons in a Recycling Process.

Reactor R1 with acceleration module and catalytic module, which fulfils the functions of:
deceleration module 4;
tribostatic voltage generator 4.

Reactor R1 and separator F1 are open in the test's preparatory phase.

Preparatory phase. Air is forced out with the target gas.

Atmospheric air fills the reactor's internal volume. The concentrations of nitrogen and oxygen in atmospheric air by mass are 76.37% and 23.225% respectively. The ratio between the relative numbers of nitrogen molecules and oxygen molecules is 3.288. A pressure cylinder containing methane NG, stream S1, is connected to the gas mixture inlet. Gas is fed into the inlet from the gas cylinder at a flow rate of 110 to 130 g/m until the maximum methane concentration is attained. Analysis of gas in the reactor:

| | | Unit of | | |
|---|---|---|---|---|
| Gas | Value | measurement | Method | Accreditation |
| Methane | 92.40 | % volume | ISO 6947-3.4 | SA |
| Oxygen | 1.772 | % volume | ISO 6947-3.4 | SA |
| Nitrogen | 5.827 | % volume | ISO 6947-3.4 | SA |

A liquid sorbent-methyl ester (FAME)—was fed into reactor R1, with the surface level above acceleration module R1. The input FAME liquids do not contain hydrocarbon fuel fractions.

Recycling of gas from separator F1 is used with the help of gas ventilator C2, with the gas fed back into the reactor.

The liquid sorbent in the boiler of reactor R1 is heated to 200° C. Gas ventilator C2 is activated. The gas mixture is fed back into the reactor inlet and into the acceleration module. The gas and liquid mixture is driven from the acceleration module at a speed of from 200 to 400 m/s into the reactor space, where it comes into contact with the catalytic space that fulfils the functions of:
deceleration module 4;
tribostatic voltage generator 4a, 4b;

After leaving the reaction space, the gas and liquid mixture is cooled in water cooler E3 and enters separator F1. In the separator the gas is separated from the liquid and enters the inlet of gas pump C2. The cycle of the gas mixture's movement between the inlet and outlet of gas ventilator C2 is repeated. Condensation of the resulting liquid reduces the volume of gas in the unit's internal volume, which should cause a fall in pressure in the unit, but the formation of molecular hydrogen compensates for the pressure decrease and recycling leads to constant change in the gas composition. Removing molecular hydrogen from the recycled gas leads to a fall in pressure in the apparatus and allows “fresh” gas to be fed in.

### Analysis of the Product in the Boiler of Reactor R1 and in Separator F1.

Gas chromatography and measurement of the density and viscosity of two samples of fatty acid methyl esters were performed.

The gas chromatography results show that both samples are fatty acid methyl esters (FAME). In addition to FAME, the samples contain a small quantity of middle distillates. The chromatograms are typical of diesel (shown in Graph 7.)

The main difference between the sample analyses is the content of diesel, whose chromatography curves are entirely comparable. The calculated content of both samples is presented in the following table.

| | Content (% mass) | |
|---|---|---|
| Composition | 1440 (FAME) | 1441 (3GTLFAME) |
| FAME - C16 fatty acid | 4.7 | 6.9 |
| FAME - C18 fatty acid | 85.7 | 77.8 |
| FAME - remaining fatty acids | 3.2 | 0.9 |
| FAME total | 93.6 | 85.6 |
| Diesel | 6.4 | 14.4 |

The composition presented in the preceding table is in line with the samples' density and viscosity:

| | Value | |
|---|---|---|
| | 1440 | 1441 |
| Parameter | (FAME) | (3GTLFAME) |
| Density at 15° C. (kg/m³) | 880.6 | 872.3 |
| Kinematic viscosity at 40° C. (mm²/s) | 4.53 | 3.89 |

Sample 1441 (FAME) contains a greater quantity of diesel (diesel has a lower density than FAME) with a lower average density and viscosity value than sample 1440 (FAME) with a lower diesel content. The higher diesel content in sample 1441 (FAME) is reflected in the calculation of the hydrocarbons content:

| | |
|---|---|
| Hydrocarbon group | Content (% mass) |

| (analysis of the | Sample 1440 | Sample 1441 |
|---|---|---|
| number of carbon atoms) | (FAME) | (3GTLFAME) |
| up to C7 | <0.1 | 0.2 |
| up to C8 | 0.1 | 0.2 |
| up to C9 | 0.2 | 0.5 |
| up to C10 | 0.5 | 1.4 |
| up to C11 | 0.9 | 2.5 |
| up to C12 | 1.3 | 3.8 |
| up to C13 | 1.8 | 5.3 |
| up to C14 | 2.3 | 6.9 |
| up to C15 | 2.7 | 8.3 |
| up to C16 | 3.1 | 9.7 |
| up to C17 | 3.4 | 10.8 |
| up to C18 | 3.8 | 11.9 |
| Hydrocarbons | 96.2 | 88.1 |
| over C18 + FAME | | |

Analysis of Example 6 and the liquid products makes it possible to draw the following conclusion:

### Synthesis of Hydrocarbon Products->Diesel is Caused:

1. By the breakdown of nitrogen and oxygen molecules, followed by synthesis of these molecules and the release of excess energy.
2. If there is sufficient excess energy in the catalytic zone during the breakdown of air molecules, reactions 5, 7, 13, 14, 15 and 16 air->methane commence, releasing 24.7 MJ per kg of air.
3. The higher the concentration of nitrogen and oxygen in the reactor, the more energy is generated and the more liquid with greater density is produced-reaction 24.
4. By the breakdown of methyl ester (FAME) molecules and subsequent restructuring of radicals arising in plasma, with synthesis of chemical substances containing oxygen.

The low concentration of nitrogen and oxygen in the gas fed in determines the low product yield.

The increase in the concentration of molecular methane and in generated energy is a consequence of the decrease in the concentration of nitrogen and oxygen and of the processes described in reactions 5, 7, 13, 14, 15 and 16. Methyl esters are converted into hydrocarbons thanks to the generated energy. These processes come under the patent being applied for

See Table 1-Overview of Physico-chemical Reactions for details of all the reactions.

### Example 7

Formation of n-Alkanes from Vegetable Oil in a Recycling Process.

Reactor R1 with acceleration module and catalytic module, which fulfils the functions of:
deceleration module 4;
tribostatic voltage generator 4a, 4b;
Preparatory phase. Air is forced out with the target gas.

Atmospheric air fills the reactor's internal volume. The concentrations of nitrogen and oxygen in atmospheric air by mass are 76.37% and 23.225% respectively. The ratio between the relative numbers of nitrogen molecules and oxygen molecules is 3.288. A pressure cylinder containing methane NG, stream S1, is connected to the input gas mixture inlet. Gas is fed into the inlet from the gas cylinder at a flow rate of 110 to 130 g/m until the maximum methane concentration is attained. Analysis of gas in the reactor after gas is fed in:

| | | Unit of | | |
|---|---|---|---|---|
| Gas | Value | measurement | Method | Accreditation |
| Methane | 93.40 | % volume | ISO 6947-3.4 | SA |
| Oxygen | 2.170 | % volume | ISO 6947-3.4 | SA |
| Nitrogen | 4.427 | % volume | ISO 6947-3.4 | SA |

Recycling of gas from separator F1 is used with the help of gas ventilator C2, with the gas fed back into reactor R1.

A liquid sorbent-rapeseed oil—was fed into the reactor, with the surface level above acceleration module R1. Rapeseed oil does not contain hydrocarbon fuel fractions and methyl esters. The liquid sorbent in the boiler of the reactor is heated to 146° C. The gas ventilator is activated. The gas mixture is fed from ventilator C2 into the reactor inlet and into the acceleration module. The gas and liquid mixture is driven from the acceleration module at a speed of from 200 to 400 m/s into the reactor space, where it comes into contact with the catalytic space that fulfils the functions of:
deceleration module 4;
tribostatic voltage generator 4a, 4b;

After leaving the reaction space, the gas and liquid mixture is cooled in water cooler E3 and enters separator F1. In the separator the gas is separated from the liquid and enters the inlet of gas pump C2. The cycle is repeated.

| | Content (% mass) | | |
|---|---|---|---|
| Composition | 26920163 | 26920162 | 29920161 |
| FAME - C16 fatty acid | — | 2.4 | 2.4 |
| FAME - C18 fatty acid | — | 46.7 | 50.9 |
| FAME - remaining fatty acids | — | 0.7 | 0.7 |
| FAME total | — | 49.8 | 53.9 |
| Diesel | — | 50 | 44.6 |
| Rapeseed oil | 100 | 0.2 | 1.5 |

### Analysis of the Product in the Boiler of Reactor R1 and of Two Product Samples in Three-Phase Separator F1.

The density and viscosity of three fuel samples were determined. The composition of these samples was analysed by gas chromatography.

The gas chromatography results showed that sample 26920163 is pure vegetable oil.

Samples 26920162 and 29920161 contain traces of vegetable oil (up to 2% by mass). The main components of these two samples are FAME and middle distillate:

The main difference between samples 26920162 and 29920161 is their FAME, diesel and vegetable oil content ratio. The diesel chromatography reading is comparable for both samples. Density and viscosity results are shown in Graph 8.

Composition of the analyzed samples:

| | Value | | |
|---|---|---|---|
| Parameter | 26920163 | 26920162 | 29920161 |
| Density at 15° C. (kg/m³) | 920.4 | 858.6 | 865.4 |
| Kinematic viscosity at 40° C. | 35.40 | 3.74 | 4.35 |
| (mm²/s) | | | |

Content of hydrocarbon chains by number of carbon chains (cumulative)

| | Content (% mass) | | |
|---|---|---|---|
| Number of carbon atoms | 26920163 | 26920162 | 29920161 |
| up to C7 | — | 0.1 | 0.2 |
| up to C8 | — | 0.2 | 0.4 |
| up to C9 | — | 0.5 | 0.7 |
| up to C10 | — | 1.5 | 1.6 |
| up to C11 | — | 3.1 | 2.6 |
| up to C12 | — | 5.1 | 3.8 |
| up to C13 | — | 8.5 | 5.9 |
| up to C14 | — | 13.6 | 9.0 |
| up to C15 | — | 20.9 | 13.8 |
| up to C16 | — | 28.2 | 19.4 |
| up to C17 | — | 34.9 | 25.5 |
| up to C18 | — | 40.5 | 31.5 |
| Hydrocarbons over C18 + FAME | — | 99.8 | 98.5 |
| Vegetable oil | 100 | 100 | 100 |

Analysis of Example 7 and the liquid products makes it possible to draw the following conclusion:

### Synthesis of the Hydrocarbon Products->Diesel is Caused:

1. By the breakdown of nitrogen and oxygen molecules, followed by synthesis of these molecules and the release of excess energy.
2. If there is sufficient excess energy in the catalytic zone during the breakdown of air molecules, reactions 5, 7, 13, 14, 15 and 16 air->methane commence, releasing 24.7 MJ per kg of air.
3. The higher the concentration of nitrogen and oxygen in the reactor, the more energy is generated and the more liquid with greater density is produced from the methane by reaction 24.
4. By the breakdown of triglyceride molecules in the molecules of vegetable oil and subsequent restructuring of radicals arising in plasma by synthesis of chemical substances containing oxygen and of diesel fractions. The low concentration of nitrogen and oxygen in the gas fed in determines the low product yield.
5. In this example, conversion of methane into molecules of nitrogen and oxygen as additional sources for synthesis of components containing oxygen can be assumed.
6. The absence of glycerine in the analysis results indicates its disruption as a chemical compound and the synthesis of other elements from its fragments.

The increase in the concentration of molecular methane and in generated energy occurs as a consequence of the decrease in the concentration of nitrogen and oxygen and of the processes described in reactions 5, 7, 13, 14, 15, 16 and 17. The destruction of bonds in triglyceride molecules and subsequent synthesis of hydrocarbons occurs due to the generated energy. These processes come under the patent being applied for

See Table 1-Overview of Physico-chemical Reactions for details of all the reactions.

### Example 8

Formation of n-Alkanes from Vegetable Oil in a Recycling Process.

Reactor R1 with acceleration module and catalytic module, which fulfils the functions of:
deceleration module 4;
tribostatic voltage generator 4a, 4b.

Preparatory phase. Air is forced out with the target gas.

| | | Unit of | | |
|---|---|---|---|---|
| Gas | Value | measurement | Method | Accreditation |
| Methane | 0.00 | % volume | ISO 6974-3.4 | SA |
| Oxygen | 9.22 | % volume | ISO 6974-3.4 | SA |
| Nitrogen | 90.78 | % volume | ISO 6974-3.4 | SA |

Atmospheric air fills the reactor's internal volume. The concentrations of nitrogen and oxygen in atmospheric air by mass are 76.37% and 23.225% respectively. The ratio between the relative numbers of nitrogen molecules and oxygen molecules is 3.288. A pressure cylinder containing nitrogen NG, stream S1, is connected to the gas mixture inlet. Gas is fed into the inlet from the gas cylinder at a flow rate of 110 to 130 g/m until the maximum nitrogen concentration is attained. Analysis of gas in the reactor after gas is fed in:

A liquid sorbent-rapeseed oil—was fed into the reactor, with the surface level above the acceleration module. Rapeseed oil does not contain hydrocarbon fuel fractions and methyl esters.

Recycling of gas from separator F1 is used with the help of gas pump C2, with the gas fed back into reactor R1.

The liquid sorbent in the boiler of the reactor is heated to 250° C. Gas ventilator C2 is activated. The gas mixture is fed back from pump C2 into the reactor inlet and into the acceleration module. The gas and liquid mixture is driven from the acceleration module at a speed of from 200 to 400 m/s into the reactor space, where it comes into contact with the catalytic space that fulfils the functions of:
deceleration module;
tribostatic voltage generator

After leaving the reaction space, the gas and liquid mixture is cooled in water cooler E3 and enters separator F1. In the separator the gas is separated from the liquid and enters the inlet of gas pump C2. The cycle is repeated.

Analysis of Input Materials and Products from Separator F1.

Gas chromatography analysis of two samples of organic liquids was performed. Both liquids were analysed first using high-temperature gas chromatography (HTGC). After the nature of the present components was determined, the sample labelled “N_{1, 20. 4. 2018}” was identified as pure rapeseed oil, and the sample labelled “N_{2, 20. 4. 2018}” was analysed using a further chromatography method with more effective separation.

The analysis reveals that sample “N_{1, 20. 4. 2018}” is pure rapeseed oil formed of a mixture of triglycerides of fatty acids. By contrast, the sample labelled “N_{2, 20. 4. 2018}” is an almost pure mixture of hydrocarbons containing just 2.1% vegetable oil by mass (shown in Graph 9).

More detailed chromatographic analysis of sample “N_{2, 20. 4. 2018}” found that the distribution of hydrocarbons in this sample is typical for middle distillates. In terms of the representation of n-alkanes and overall distribution of hydrocarbons, sample “N_{2, 20. 4. 2018}” can be best compared to diesel or possibly gas oil. Shown in Graph 10.

Distribution of hydrocarbons in sample “N_{2, 20. 4. 2018}” is shown in Graph 11:

The table shows the distribution of hydrocarbons expressed as the cumulative content of hydrocarbon groups in terms of carbon atoms in a molecule.

| Hydrocarbon group (by carbon atoms) | Content % mass |
|---|---|
| up to C8 | 0.1 |
| up to C9 | 0.7 |
| up to C10 | 3.8 |
| up to C11 | 11.2 |
| up to C12 | 19.8 |
| up to C13 | 30.6 |
| up to C14 | 42.1 |
| up to C15 | 53.1 |
| up to C16 | 63.2 |
| up to C17 | 72.2 |
| up to C18 | 79.8 |
| up to C19 | 86.1 |
| up to C20 | 90.2 |
| up to C21 | 93.1 |
| up to C22 | 95.4 |
| up to C23 | 96.6 |
| up to C24 | 97.3 |
| up to C25 | 97.6 |
| up to C26 | 97.8 |
| up to C27 | 97.9 |
| Vegetable oil | 100 |

Analysis of Example 8 and the liquid reaction products makes it possible to draw the following conclusion:

### Synthesis of Hydrocarbon Products->Diesel is Caused:

1. By the breakdown of nitrogen and oxygen molecules, followed by synthesis of these molecules and the release of excess energy.
2. If there is sufficient excess energy in the catalytic zone during the breakdown of air molecules, reactions 5, 7, 13, 14, 15, 16 and 17 air->methane commence, releasing 24.7 MJ per kg of air.
3. The higher the concentration of nitrogen and oxygen in the reactor, the more energy is generated and the more liquid with greater density is produced from the methane by reaction 3.
4. In this example, there was no methane in the fed-in gas. Synthesis of methane and normal alkanes was possible:
   in the synthesis of methane from nitrogen and oxygen according to reactions 5, 7, 13, 14, 15, 16 and 17 and the subsequent synthesis of normal alkanes according to reaction 24, or;
   by the breakdown of triglycerides in the vegetable oil molecules and restructuring of radicals arising in plasma, with synthesis of normal alkanes.
5. The absence of glycerine in the analysis results indicates its disruption as a chemical compound and the synthesis of other elements from its fragments.

The increase in the concentration of molecular methane and in generated energy occurs as a consequence of the decrease in the concentration of nitrogen and oxygen and of the processes described in reactions 5, 7, 13, 14, 15, 16 and 17. The destruction of bonds in triglyceride molecules and subsequent synthesis of hydrocarbons occurs due to the generated energy. These processes come under the patent being applied for

See Table 1-Overview of Physico-chemical Reactions for details of all the reactions.

### Example 9

Formation of Organic Synthesis Products from Vegetable Oil in a Nitrogenous Environment.

Reactor R1 with acceleration module and catalytic module, which fulfils the functions of:
deceleration module 4;
tribostatic voltage generator 4a, 4b;

Preparatory phase. Air is forced out with the target gas.

Atmospheric air fills the reactor's internal volume. The concentrations of nitrogen and oxygen in atmospheric air by mass are 76.37% and 23.225% respectively. The ratio between the relative numbers of nitrogen molecules and oxygen molecules is 3.288. A pressure cylinder containing nitrogen NG, stream S1, is connected to the gas mixture inlet.

Recycling of gas from separator F1 with the help of gas ventilator C2, with the gas fed back into the reactor, is not used.
1. Atmospheric pressure 97,990 Pa.
2. After the apparatus is closed, at the given atmospheric pressure there are 325 grams of air in it, molecular mass 28.98 g/mol, including 248 g of nitrogen (76.3% by mass) and 75 grams of oxygen (23.07% by mass).
3. 1^{st} feed of nitrogen from the gas cylinder, quantity 11.33 g. The rate of flow S1 of the supplied gas is 0.7 m³/h; overpressure in the apparatus after the gas is fed in is 3.48 kPa. The average temperature in the apparatus when the gas is fed in is 22° C.
4. 1^{st} output of reaction gases: the valve to let gas out the reactor is opened until the overpressure value is 0 kPa. 12.00 grams of gas is extracted. The average temperature in the installation when the gas is discharged is 22° C.
5. 2^{nd} feed of nitrogen from the gas cylinder, quantity 22.67 g. The rate of flow S1 of the supplied gas is 0.7 m³/h; overpressure in the apparatus after the gas is fed in is 6.89 kPa. The average temperature in the apparatus when the gas is fed in is 22.5° C.
6. 2^{nd} output of reaction gases: the valve to let gas out the reactor is opened until the overpressure value is 3.48 kPa. 12.03 grams of gas is extracted. The average temperature in the installation when the gas is discharged is 22.5° C.
7. 3^{rd} feed of nitrogen from the gas cylinder, quantity 11.33 g. The rate of flow S1 of the supplied gas is 0.7 m³/h; overpressure in the apparatus after the gas is fed in is 6.48 kPa. The average temperature in the apparatus when the gas is fed in is 23° C.
8. 3^{rd} output of reaction gases: the valve to let gas out the reactor is opened until the overpressure value is 3.48 kPa. 11.62 grams of gas is extracted. The average temperature in the installation when the gas is discharged is 23° C.

Calculated composition of gases in the apparatus before the process:

| | | Unit of | | |
|---|---|---|---|---|
| Gas | Value | measurement | Method | Accreditation |
| Methane | 0.00 | % volume | ISO 6947-3.4 | SA |
| Oxygen | 20.21 | % volume | ISO 6947-3.4 | SA |
| Nitrogen | 79.79 | % volume | ISO 6947-3.4 | SA |

A liquid sorbent-rapeseed oil—was fed into reactor R1, with the surface level above acceleration module. Rapeseed oil does not contain hydrocarbon fuel fractions and methyl esters.

The liquid sorbent in the boiler of reactor R1 is heated to 250° C. At this temperature, nitrogen starts to be fed into the apparatus according to the following algorithm:
The control system issues an instruction to maintain pressure in the separator at 34.475 kPa;
If pressure in the separator falls below the set value, the valve for feeding nitrogen from the cylinder into the reactor and then into the acceleration module is opened;
The gas and liquid mixture is driven at a speed of from 30 to 40 m/s from the acceleration module into the reactor space and catalyst space, which fulfils the function of:
   deceleration module;
   tribostatic voltage generator
when the set pressure value is attained, the feed valve for gas from the gas cylinder is closed and the output valve for letting reaction gas out of the apparatus is opened;
If the pressure in the separator falls below the set value, the output valve for letting reaction gas out of the apparatus is closed and the valve for feeding nitrogen from the gas cylinder into the reactor is opened.

The product was removed from the separator after the test.

Analysis of the Product from Separator F1:

One sample of organic liquid supplied with the label “14. 8. 18” (nitrogen without recycling) was analysed. The liquid was analysed by gas chromatography-mass spectrometry (GC-MS) in order to identify the substances present. Additionally, the sample was screened with high-temperature gas chromatography.

Sample “14. 8. 18” (nitrogen, without recycling) is a two-component mixture, approximately 75% of which is the upper organic layer and 25% the lower water part. The analysis results show that approximately more than 50% of the organic part comprises a mixture of higher fatty acids, dominated by acids with 18 carbon atoms in a molecule (oleic acid and stearic acid). Approximately 4% of the organic part is vegetable oil. The rest of the organic part is a mixture of organic substances, primarily fatty acid methyl esters (FAME), hydrocarbons (mainly C14 and C18), alcohols and aldehydes. The chromatography reading from the GC-MS analysis is presented in the appendix along with the identified substances (the maximum values for the vegetable oil are not included in the appendix, as this cannot be detected by standard GC-MS owing to its extremely high boiling point).

Chromatogram of sample “14. 8. 18” (nitrogen, without recycling) is shown in Graph 12.

### Interpretation of the Chromatogram:

| % mass | Hydrocarbon name | Chemical formula |
|---|---|---|
| 0.14 | cyclohexane | C6H12 |
| 0.82 | hexane, 2-methyl- | C7H16 |
| 0.7 | hexane, 3-methyl- | C7H16 |
| 0.19 | hexane, 3-methyl- | C7H16 |
| 0.08 | hexane, 3-methyl- | C7H16 |
| 0.45 | Heptane | C7H16 |
| 0.22 | cyclohexane, methyl- | C7H16 |
| 0.06 | ethylcyclopentane | C7H14 |
| 0.89 | toluene | C7H8 |
| | nonane | C9H20 |
| 0.05 | decane | C10H22 |
| 0.11 | tetradecene | CH3(CH2)11CH═CH2 |
| 0.06 | tetradecane | C14H30 |
| 0.21 | tetradecane | C14H30 |
| 0.04 | tetradecane | C14H30 |
| 0.09 | tetradecane | C14H30 |
| 0.03 | tetradecane | C14H30 |
| 0.04 | tetradecane | C14H30 |
| 0.07 | tetradecane | C14H30 |
| 0.06 | tetradecane | C14H30 |
| 0.05 | tetradecane | C14H30 |
| 0.09 | tetradecane | C14H30 |
| 0.02 | tetradecane | C14H30 |
| 0.02 | tetradecane | C14H30 |
| 0.04 | tetradecane | C14H30 |
| 0.12 | tetradecane | C14H30 |
| 0.39 | pentadecene | C15H30 |
| 0.81 | pentadecene | C15H30 |
| 0.03 | pentadecene | C15H30 |
| 0.24 | pentadecane | C15H32 |
| 0.06 | pentadecane | C15H32 |
| 0.04 | pentadecane | C15H32 |
| 0.09 | pentadecane | C15H32 |
| 0.02 | pentadecane | C15H32 |
| 0.04 | pentadecane | C15H32 |
| 0.03 | pentadecane | C15H32 |
| 0.1 | pentadecane | C15H32 |
| 0.09 | pentadecane | C15H32 |
| 0.07 | pentadecane | C15H32 |
| 0.15 | pentadecane | C15H32 |
| 0.08 | hexadecene | C16H32 |
| 0.18 | hexadecene | C16H32 |
| 0.1 | hexadecene | C16H32 |
| 0.21 | hexadecane | C16H34 |
| 0.02 | hexadecane | C16H34 |
| 0.03 | hexadecane | C16H34 |
| 0.01 | hexadecane | C16H34 |
| 0.01 | hexadecane | C16H34 |
| 0.11 | 1-decyl-1-cyclohexene | C16H32 |
| 0.08 | 1-decyl-1-cyclohexene | C16H32 |
| 0.07 | 1-decyl-1-cyclohexene | C16H32 |
| 0.04 | 1-decyl-1-cyclohexene | C16H32 |
| 0.2 | heptadecene | CH3(CH2)14CH═CH2 |
| 0.68 | heptadecene | CH3(CH2)14CH═CH2 |
| 0.27 | heptadecene | CH3(CH2)14CH═CH2 |
| 0.23 | heptadecane | C17H36 |
| 0.09 | heptadecane | C17H36 |
| 0.03 | heptadecane | C17H36 |
| 0.1 | heptadecane | C17H36 |
| 0.11 | heptadecane | C17H36 |
| 0.06 | heptadecane | C17H36 |
| 0.04 | heptadecane | C17H36 |
| 0.08 | heptadecane | C17H36 |
| 0.11 | heptadecane | C17H36 |
| 0.21 | octadecene | C18H36 |
| 0.51 | octadecene | C18H36 |
| 0.49 | octadecene | C18H36 |
| 0.06 | octadecene | C18H36 |
| 0.03 | octadecene | C18H36 |
| 0.22 | octadecane | C18H38 |
| 0.04 | octadecane | C18H38 |
| 0.15 | octadecane | C18H38 |
| 0.48 | octadecane | C18H38 |
| 0.35 | octadecane | C18H38 |
| 0.19 | octadecane | C18H38 |
| 0.05 | octadecane | C18H38 |
| 0.05 | octadecane | C18H38 |
| 0.43 | octadecane | C18H38 |
| 0.04 | octadecane | C18H38 |
| 0.17 | octadecane | C18H38 |
| 0.06 | octadecane | C18H38 |
| 13.28 | | |

| % mass | Hydrocarbon name | Chemical formula | Chemical formula |
|---|---|---|---|
| 0.04 | acetic acid | CH3COOH | C2H4O2 |
| 0.01 | acetic acid | CH3COOH | C2H4O2 |
| 0.04 | acetic acid | CH3COOH | C2H4O2 |
| 0.17 | acetic acid | CH3COOH | C2H4O2 |
| 0.08 | acetic acid | CH3COOH | C2H4O2 |
| 0.02 | butanoic acid | CH3CH2CH2—COOH | C3H7COOH |
| | pentanoic acid | CH3CH2CH2CH27—COOH | C5H10O2 |
| 0.04 | hexanoic acid | CH3(CH2)4COOH | C6H12O2 |
| 0.14 | heptanoic acid | CH3(CH2)5COOH | C7H14O2 |
| 0.06 | heptanoic acid | CH3(CH2)5COOH | C7H14O2 |
| 0 | heptanoic acid | CH3(CH2)5COOH | C7H14O2 |
| 0.03 | heptanoic acid | CH3(CH2)5COOH | C7H14O2 |
| 0.01 | heptanoic acid | CH3(CH2)5COOH | C7H14O2 |
| 0 | heptanoic acid | CH3(CH2)5COOH | C7H14O2 |
| 0.05 | heptanoic acid | CH3(CH2)5COOH | C7H14O2 |
| 0.1 | octanoic acid | CH3(CH2)6COOH | C8H16O2 |
| 0 | octanoic acid | CH3(CH2)6COOH | C8H16O2 |
| 0.01 | octanoic acid | CH3(CH2)6COOH | C8H16O2 |
| 0.16 | nonanoic acid | CH3(CH2)7COOH | C9H18O2 |
| 0.03 | nonanoic acid | CH3(CH2)7COOH | C9H18O2 |
| 0.05 | nonanoic acid | CH3(CH2)7COOH | C9H18O2 |
| 0.01 | nonanoic acid | CH3(CH2)7COOH | C9H18O2 |
| 0.07 | nonanoic acid | CH3(CH2)7COOH | C9H18O2 |
| 0.12 | nonanoic acid | CH3(CH2)7COOH | C9H18O2 |
| 1.87 | decanoic acid | CH3(CH2)8COOH | C10H20O2 |
| 2.38 | n-hexadecanoic acid | CH3(CH2)14COOH | C16H32O2 |
| 0.02 | n-hexadecanoic acid | CH3(CH2)14COOH | C16H32O2 |
| 0 | n-hexadecanoic acid | CH3(CH2)14COOH | C16H32O2 |
| 53.09 | oleic + stearic acids | CH3(CH2)27CH═CH(CH2)7COOH + C17H35CO2H | C18H32O2 + C18H36O2 |
| 0 | oleic + stearic acids | CH3(CH2)27CH═CH(CH2)7COOH + C17H35CO2H | C18H32O2 + C18H36O2 |
| 0.15 | oleic + stearic acids | CH3(CH2)27CH═CH(CH2)7COOH + C17H35CO2H | C18H32O2 + C18H36O2 |
| 2.36 | oleic + stearic acids | CH3(CH2)27CH═CH(CH2)7COOH + C17H35CO2H | C18H32O2 + C18H36O2 |
| 0.71 | oleic + stearic acids | CH3(CH2)27CH═CH(CH2)7COOH + C17H35CO2H | C18H32O2 + C18H36O2 |
| 0.51 | oleic + stearic acids | CH3(CH2)27CH═CH(CH2)7COOH + C17H35CO2H | C18H32O2 + C18H36O2 |
| 0.02 | oleic + stearic acids | CH3(CH2)27CH═CH(CH2)7COOH + C17H35CO2H | C18H32O2 + C18H36O2 |
| 0 | oleic + stearic acids | CH3(CH2)27CH═CH(CH2)7COOH + C17H35CO2H | C18H32O2 + C18H36O2 |
| 0.17 | oleic + stearic acids | CH3(CH2)27CH═CH(CH2)7COOH + C17H35CO2H | C18H32O2 + C18H36O2 |
| 0.51 | oleic + stearic acids | CH3(CH2)27CH═CH(CH2)7COOH + C17H35CO2H | C18H32O2 + C18H36O2 |
| 0.04 | oleic + stearic acids | CH3(CH2)27CH═CH(CH2)7COOH + C17H35CO2H | C18H32O2 + C18H36O2 |
| 0.04 | oleic + stearic acids | CH3(CH2)27CH═CH(CH2)7COOH + C17H35CO2H | C18H32O2 + C18H36O2 |
| 0.07 | oleic + stearic acids | CH3(CH2)27CH═CH(CH2)7COOH + C17H35CO2H | C18H32O2 + C18H36O2 |
| 0.41 | oleic + stearic acids | CH3(CH2)27CH═CH(CH2)7COOH + C17H35CO2H | C18H32O2 + C18H36O2 |
| 0.02 | oleic + stearic acids | CH3(CH2)27CH═CH(CH2)7COOH + C17H35CO2H | C18H32O2 + C18H36O2 |
| 0.25 | oleic + stearic acids | CH3(CH2)27CH═CH(CH2)7COOH + C17H35CO2H | C18H32O2 + C18H36O2 |
| 0.2 | oleic + stearic acids | CH3(CH2)27CH═CH(CH2)7COOH + C17H35CO2H | C18H32O2 + C18H36O2 |
| 0.37 | oleic + stearic acids | CH3(CH2)27CH═CH(CH2)7COOH + C17H35CO2H | C18H32O2 + C18H36O2 |
| 0.17 | oleic + stearic acids | CH3(CH2)27CH═CH(CH2)7COOH + C17H35CO2H | C18H32O2 + C18H36O2 |
| 0.37 | oleic + stearic acids | CH3(CH2)27CH═CH(CH2)7COOH + C17H35CO2H | C18H32O2 + C18H36O2 |
| 0.68 | oleic + stearic acids | CH3(CH2)27CH═CH(CH2)7COOH + C17H35CO2H | C18H32O2 + C18H36O2 |
| 0.05 | oleic + stearic acids | CH3(CH2)27CH═CH(CH2)7COOH + C17H35CO2H | C18H32O2 + C18H36O2 |
| 0.02 | oleic + stearic acids | CH3(CH2)27CH═CH(CH2)7COOH + C17H35CO2H | C18H32O2 + C18H36O2 |
| 0.03 | oleic + stearic acids | CH3(CH2)27CH═CH(CH2)7COOH + C17H35CO2H | C18H32O2 + C18H36O2 |
| 0.03 | oleic + stearic acids | CH3(CH2)27CH═CH(CH2)7COOH + C17H35CO2H | C18H32O2 + C18H36O2 |
| 0.03 | oleic + stearic acids | CH3(CH2)27CH═CH(CH2)7COOH + C17H35CO2H | C18H32O2 + C18H36O2 |
| 0.03 | oleic + stearic acids | CH3(CH2)27CH═CH(CH2)7COOH + C17H35CO2H | C18H32O2 + C18H36O2 |
| 0.04 | oleic + stearic acids | CH3(CH2)27CH═CH(CH2)7COOH + C17H35CO2H | C18H32O2 + C18H36O2 |
| 65.88 | | | |
| 3.45 | octadec-9-en-1-ol | | C18H36O |
| 1.25 | octadecen-1-ol | CH3(CH2)7CH═CH(CH2)7CH2OH | C18H36O |
| 0.34 | octadecen-1-ol | CH3(CH2)7CH═CH(CH2)7CH2OH | C18H36O |
| 0.07 | octadecen-1-ol | CH3(CH2)7CH═CH(CH2)7CH2OH | C18H36O |
| 0.04 | octadecen-1-ol | CH3(CH2)7CH═CH(CH2)7CH2OH | C18H36O |
| 0.02 | octadecen-1-ol | CH3(CH2)7CH═CH(CH2)7CH2OH | C18H36O |
| 0.05 | octadecen-1-ol | CH3(CH2)7CH═CH(CH2)7CH2OH | C18H36O |
| 0.03 | octadecen-1-ol | CH3(CH2)7CH═CH(CH2)7CH2OH | C18H36O |
| 0 | octadecen-1-ol | CH3(CH2)7CH═CH(CH2)7CH2OH | C18H36O |
| 0.07 | octadecen-1-ol | CH3(CH2)7CH═CH(CH2)7CH2OH | C18H36O |
| 0.18 | octadecen-1-ol | CH3(CH2)7CH═CH(CH2)7CH2OH | C18H36O |
| 0.06 | octadecen-1-ol | CH3(CH2)7CH═CH(CH2)7CH2OH | C18H36O |
| 0.01 | octadecen-1-ol | CH3(CH2)7CH═CH(CH2)7CH2OH | C18H36O |
| 0.29 | octadecen-1-ol | CH3(CH2)7CH═CH(CH2)7CH2OH | C18H36O |
| 0 | octadecen-1-ol | CH3(CH2)7CH═CH(CH2)7CH2OH | C18H36O |
| 0.09 | octadecen-1-ol | CH3(CH2)7CH═CH(CH2)7CH2OH | C18H36O |
| 0.15 | octadecen-1-ol | CH3(CH2)7CH═CH(CH2)7CH2OH | C18H36O |

| % hmot. | Název uhlovodíku | Chemical formula | Chemical formula |
|---|---|---|---|
| 1.27 | palmitic acid methyl ester | | C17H34O2 |
| 0.03 | palmitic acid methyl ester | | C17H34O2 |
| 0.09 | palmitic acid methyl ester | | C17H34O2 |
| 0.04 | palmitic acid methyl ester | | C17H34O2 |
| 0.61 | palmitic acid methyl ester | | C17H34O2 |
| 1.05 | palmitic acid methyl ester | | C17H34O2 |
| 4.99 | oleic acid methyl ester | CH₃(CH₂)₇CH═CH(CH₂)₇COOH | C18H34O2 |
| 0.54 | oleic acid methyl ester | CH₃(CH₂)₇CH═CH(CH₂)₇COOH | C18H34O2 |
| 0 | oleic acid methyl ester | CH₃(CH₂)₇CH═CH(CH₂)₇COOH | C18H34O2 |
| 0.01 | oleic acid methyl ester | CH₃(CH₂)₇CH═CH(CH₂)₇COOH | C18H34O2 |
| 0 | oleic acid methyl ester | CH₃(CH₂)₇CH═CH(CH₂)₇COOH | C18H34O2 |
| 0.41 | oleic acid methyl ester | CH₃(CH₂)₇CH═CH(CH₂)₇COOH | C18H34O2 |
| 0 | oleic acid methyl ester | CH₃(CH₂)₇CH═CH(CH₂)₇COOH | C18H34O2 |

### Overall Content of Components of the Product:

| Substance name | Unit of measurement | Value |
|---|---|---|
| Hydrocarbons - Alkanes | % mass | 6.45 |
| Hydrocarbons - Alkenes | % mass | 3.73 |
| Hydrocarbons-i-Alkanes | % mass | 2.07 |
| Hydrocarbons - Aromatics | % mass | 0.89 |
| Hydrocarbons - Naphthenes | % mass | 0.14 |
| Aldehyde | % mass | 1.81 |
| Acid | % mass | 65.88 |
| Oleyl Alcohol | % mass | 7.92 |
| Ester | % mass | 9.04 |
| Total | | 97.93 |

Analysis of Example 9 and the liquid reaction products makes it possible to draw the following conclusion:

### Synthesis of Hydrocarbon Products is Caused:

1. By the breakdown of nitrogen and oxygen molecules, followed by synthesis of these molecules and the release of excess energy.
2. If there is sufficient excess energy in the catalytic zone during the breakdown of air molecules, reactions 5, 7, 13, 14, 15, 16 and 17 air->water commence, releasing 12.2 MJ per kg of air.
3. If there is sufficient excess energy in the catalytic zone during the air->water reaction, reactions 5, 7, 13, 14, 15, 16 and 17 air->methane commence, releasing 24.7 MJ per kg of air.
4. If there is sufficient energy in various catalyst zones during the reaction of methane in air, the direct conversion of methane into a normal alkane and hydrogen according to reaction 24 commences. To a lesser degree, in the event of insufficient energy the synthesis of alkanes, following by synthesis of esters, with the presence of oxygen, is possible, as is synthesis of alcohols from alkanes.
5. The production of free fatty acids is linked to hydrolysis of triglycerides based on a reaction between them and the water produced by the air->water reaction.

The increase in the concentration of molecular methane and in generated energy occurs as a consequence of the decrease in the concentration of nitrogen and oxygen and of the processes described in reactions 5, 7, 13, 14, 15, 16 and 17. The destruction of bonds in triglyceride molecules and subsequent synthesis of organic synthesis products occurs due to the generated energy. These processes come under the patent being applied for

See Table 1-Overview of Physico-chemical Reactions for details of all the reactions.

### Example 10

Formation of Organic Synthesis Products from Vegetable Oil in an Air Environment.

Reactor R1 with acceleration module and catalytic module, which fulfils the functions of:
deceleration module 4;
tribostatic voltage generator 4a, 4b;

Atmospheric air fills the reactor's internal volume. The concentrations of nitrogen and oxygen in atmospheric air by mass are 76.37% and 23.225% respectively. The ratio between the relative numbers of nitrogen molecules and oxygen molecules is 3.288. An air compressor is connected to the gas mixture inlet.

Calculated composition of gases in the apparatus before the process:

| | | Unit of | | |
|---|---|---|---|---|
| Gas | Value | measurement | Method | Accreditation |
| Methane | 0.00 | % volume | ISO 6947-3.4 | SA |
| Oxygen | 23.23 | % volume | ISO 6947-3.4 | SA |
| Nitrogen | 76.37 | % volume | ISO 6947-3.4 | SA |

A liquid sorbent-rapeseed oil—was fed into the reactor, with the surface level above the acceleration module. Rapeseed oil does not contain hydrocarbon fuel fractions and methyl esters.

Recycling of gas from the separator with the help of the gas ventilator, with the gas fed back into the reactor, is not used.

The liquid sorbent in the boiler of reactor R1 is heated to 250° C. At this temperature, air starts to be fed into the apparatus according to the following algorithm:
The control system issues an instruction to maintain pressure in the separator at 34.475 kPa;
If pressure in the separator falls below the set value, valve V1 for feeding air from the compressor into the reactor and then into the acceleration module is opened;
The gas and liquid mixture is driven at a speed of from 20 to 40 m/s from the acceleration module into the reactor space and catalyst space, which fulfils the function of:
   deceleration module 4;.
   tribostatic voltage generator 4a, 4b;
when the set pressure value is attained, the valve for feeding air from the compressor is closed and the valve for letting the reaction gas out of the apparatus is opened;
If the pressure in the separator falls below the set value, the valve for letting reaction gas out of the apparatus is closed and the valve for feeding air from the compressor into the reactor is opened.

The product was removed from the separator after the test.

| | |
|---|---|
| 3GTL - (060620181), | Heavy product of processing of rapeseed |
| A, 6. 6. 18/1 | oil in the 3GTL process |
| 3GTL - (060620182), | Light product of processing of rapeseed |
| B, 6. 6. 18/2 | oil in the 3GTL process |

Analysis of the Product from the Three-Phase Separator F1:

Two samples of organic liquids were analysed:

Both liquids were analysed by gas chromatography-mass spectrometry (GC-MS) in order to identify the substances present. Additionally, the sample was screened with high-temperature gas chromatography (HTGC).

The analysis results show that over 90% of sample “060620181), A, 6. 6. 18/1” is vegetable oil; the remainder is mostly fatty acid methyl esters (FAME) and a smaller quantity of diacetone alcohol (<3%). The chromatography reading from the GC-MS analysis is presented in the appendix along with the identified substances (the maximum values for the vegetable oil are not included in the appendix, because this cannot be detected by standard GC-MS owing to its extremely high boiling point).

The sample labelled “(060620182), B, 6. 6. 18/2” is a mixture of FAME, saturated hydrocarbons and other oxygenous components. FAME (fatty acid methyl esters C16 to C24) make up approximately 40% of the sample.

Analysis of the GC-MS data of sample “060620182), B, 6. 6. 18/2” found that the sample contains saturated hydrocarbons ranging approximately from C12 to C19. In addition, the sample contains lighter oxygenous substances with the number of carbon atoms ranging approximately from C6 to C10. These components formed characteristic series in retention order: aldehyde with a saturated hydrocarbon chain, alkenoic acid methyl ester, alkanoic acid methyl ester, and aldehyde with an unsaturated hydrocarbon chain. Chromatography reading for sample 3GTL-(060620181), A, 6. 6. 18/1 is shown in Graph 13.

Chromatography reading for sample 3GTL-(060620182), A, 6. 6. 18/2 is illustrated in Graph 14.

The following tables present the interpretation of the chromatograms for both products:

Alcohol esters of sample 3GTL - (060620181), A, 6. 6. 18/1

| % mass | Hydrocarbon name | Chemical formula |
|---|---|---|
| 0.65 | | C6H12O2 |
| 2.77 | diacetone alcohol | C6H12O2 |
| 1.45 | FAME | C17H34O2 |
| 1.72 | FAME | |
| 24.69 | FAME | |
| 2.41 | FAME | |
| 0.96 | FAME | |
| 1.55 | FAME | |
| 0.68 | FAME | |
| 0.53 | FAME | |
| 62.59 | Vegetable oil | |

| | | |
|---|---|---|
| % mass | Hydrocarbon name | Chemical formula |

Ether 3GTL - (060620182), B, 6. 6. 18/2

| | | |
|---|---|---|
| 37.95 | FAME | C17H34O2 |
| 2.51 | FAME | C19H38O2 |
| 40.46 | | |

Aldehyde 3GTL - (060620182), B, 6. 6. 18/2

| | | |
|---|---|---|
| 1.69 | hexanal | C6H12O |
| 0.48 | methyl pentenoate | C6H10O2 |
| 1.50 | diacetone alcohol | C6H12O2 |
| 1.27 | heptanal | C7H14O |
| 0.94 | methyl hexenoate | C7H12O2 |
| 0.30 | methyl hexanoate | C7H14O2 |
| 3.47 | 2-heptenal | C7H12O |
| 1.95 | octanal | C8H16O |
| 1.90 | methyl heptenoate | C8H14O2 |
| 0.74 | methyl heptanoate | C8H16O2 |
| 3.38 | 2-octenal | C8H14O |
| 4.11 | nonanal | C9H18O |
| 1.22 | methyl octenoate | C9H16O2 |
| 3.94 | methyl octanoate | C9H18O2 |
| 2.28 | 2-nonenal | C9H16O |
| 0.91 | decanal | C10H20O |
| 0.56 | methyl nonenoate | C10H18O2 |
| 0.55 | methyl nonanoate | C10H20O2 |
| 3.63 | 2-decenal | C10H18O |
| 2.69 | 2-undecenal | C11H20O |
| 37.50 | | |

Normal alkanes

| % mass | Hydrocarbon name | Chemical formula |
|---|---|---|
| 1.85 | n-C12 | C12H26 |
| 3.85 | n-C13 | C13H28 |
| 5.74 | n-C14 | C14H30 |
| 2.84 | n-C15 | C15H32 |
| 1.82 | n-C16 | C16H34 |
| 1.71 | n-C17 | C17H36 |
| 1.07 | n-C18 | C18H38 |
| 2.20 | n-C19 | C19H40 |

Analysis of the liquid products makes it possible to draw the following conclusion:

### Synthesis of Hydrocarbon Products->Diesel is Caused:

1. By the breakdown of nitrogen and oxygen molecules, followed by synthesis of these molecules and the release of excess energy.
2. If there is sufficient excess energy in the catalytic zone during the breakdown of air molecules, reaction 1 air->water commences, releasing 12.2 MJ per kg of air.
3. If there is sufficient excess energy in the catalytic zone during the air->water reaction, reactions 5, 7, 13, 14, 15, 16 and 17 air->methane commence, releasing 24.7 MJ per kg of air.
4. If there is sufficient energy in various catalyst zones during the reaction of methane in air, the direct conversion of methane into a normal alkane and hydrogen according to reaction 24 commences. To a lesser degree, in the event of insufficient energy the synthesis of alkanes, following by synthesis of esters, with the presence of oxygen, is possible, as is synthesis of alcohols from alkanes.
5. The production of free fatty acids is linked to hydrolysis of triglycerides based on a reaction between them and the water produced by the air->water reaction.

The increase in the concentration of molecular methane and in generated energy occurs as a consequence of the decrease in the concentration of nitrogen and of the processes described in reactions 5, 7, 13, 14, 15, 16 and 17. The destruction of bonds in triglyceride molecules and subsequent synthesis of organic synthesis products occurs due to the generated energy. These processes come under the patent being applied for

| | | | | Absolute |
|---|---|---|---|---|
| | Unit of | Value in | Value in | difference |
| | measure- | example | example | in |
| Substance name | ment | 10 | 9 | examples |
| Hydrocarbons-Alkanes | % mass | 21.29 | 6.45 | 14.84 |
| Hydrocarbons-Alkenes | % mass | 0.00 | 3.73 | −3.73 |
| Hydrocarbons-i-Alkanes | % mass | 0.00 | 2.07 | −2.07 |
| Hydrocarbons-Aromatics | % mass | 0.00 | 0.89 | −0.89 |
| Hydrocarbons- | % mass | 0.00 | 0.14 | −0.14 |
| Naphthtenes | | | | |
| Aldehyde | % mass | 25.62 | 1.81 | 23.81 |
| Acid | % mass | 0.00 | 65.88 | −65.88 |
| Oleyl Alcohol | % mass | 0.00 | 7.92 | −7.92 |
| FAME | % mass | 40.85 | 0.00 | 40.85 |
| Ester | % mass | 12.25 | 9.04 | 3.21 |
| Total | | 100.00 | 97.93 | |

See Table 1-Overview of Physico-chemical Reactions for details of all the reactions.

### Example 11

Formation of Organic Synthesis Products in a Recycling Process from Water and Carbon Dioxide.

Reactor R1 with acceleration module and catalytic module, which fulfils the functions of:
deceleration module 4;
tribostatic voltage generator 4a, 4b;

Preparatory phase. Air is forced out with the target gas.

Atmospheric air fills the reactor's internal volume. The concentrations of nitrogen and oxygen in atmospheric air by mass are 76.37% and 23.225% respectively. The ratio between the relative numbers of nitrogen molecules and oxygen molecules is 3.288. A pressure cylinder containing carbon dioxide, stream S1, is connected to the input gas mixture inlet.
1. Atmospheric pressure 99,425 Pa.
2. After the apparatus is closed, at the given atmospheric pressure there are 337 grams of air in it, molecular mass 28.98 g/mol, including 258 g of nitrogen (76.3% by mass) and 78.5 grams of oxygen (23.07% by mass).
3. 1^{st} feed of carbon dioxide from the gas cylinder, quantity 17.79 g. The rate of flow S1 of the supplied gas is 0.7 m³/h; overpressure in the apparatus after the gas is fed in is 3.48 kPa. The average temperature in the apparatus when the carbon dioxide is fed in is 18° C.
4. 1^{st} output of reaction gases: the valve to let gas out of the reactor is opened until the overpressure value is 0 kPa. 12.00 grams of gas is extracted. The average temperature in the installation when the gas is discharged is 18° C.
5. 2^{nd} feed of carbon dioxide from the gas cylinder, quantity 355.87 g. The rate of flow S1 of the supplied gas is 0.7 m³/h; overpressure in the apparatus after the gas is fed in is 68.95 kPa. The average temperature in the apparatus when the carbon dioxide is fed in is 18.8° C.
6. 2^{nd} output of reaction gases: the valve to let gas out of the reactor is opened until the overpressure value is 4.65 kPa. 270 grams of gas is extracted. The average temperature in the installation when the gas is discharged is 18.8° C.
7. 3^{rd} feed of carbon dioxide from the gas cylinder, quantity 355.7 g. The rate of flow S1 of the supplied gas is 0.7 m³/h; overpressure in the apparatus after the gas is fed in is 68.95 kPa. The average temperature in the apparatus when the carbon dioxide is fed in is 19.1° C.
8. 3^{rd} output of reaction gases: the valve to let gas out of the reactor is opened until the overpressure value is 42.06 kPa. 156.95 grams of gas is extracted. The average temperature in the installation when the is discharged is 19.1° C.

Composition of gases in the apparatus before the process:

| Gas | Value | Unit of measurement |
|---|---|---|
| Carbon dioxide | 74.47 | % volume |
| Oxygen | 5.920 | % volume |
| Nitrogen | 19.49 | % volume |

A liquid sorbent-water—was fed into reactor R1, with the surface level above the acceleration module. Water does not contain hydrocarbon fuel fractions and methyl esters.

Recycling of gas from separator F1 is used with the help of gas compressor C2, with the gas fed back into the reactor.

The liquid sorbent in the boiler of reactor R1 is heated to 60° C. Compressor C2 is activated. The gas mixture from separator F1 is directed to the inlet of compressor C2 and then enters the acceleration module. The gas and liquid mixture is driven from the acceleration module at a speed of from 200 to 400 m/s into the reactor space, where it comes into contact with the catalytic space that fulfils the functions of:
deceleration module 4;
tribostatic voltage generator 4a, 4b;

After leaving the reaction space, the gas and liquid mixture is cooled in water cooler E3 and enters separator F1. In the separator the gas is separated from the liquid and enters the inlet of gas compressor C2. The cycle of the gas mixture's movement between the inlet and outlet of gas compressor C2 is repeated.

### Analysis of the Products.

The product is discharged from the separator at the end of the test. A product composed of two separate components, a water component and an organic component, is removed from the reactor boiler.

The product in the reactor boiler was separated into two components: an organic component that was on the surface and sides of the laboratory beaker and water. After the composition ratio by volume of the two components was determined, the project was homogenized by mixing and preheating to 60° C. Then 3.5 ml of the homogenized product was transferred by pipette into a 4 ml test-tube. In a centrifuge operating at 4,400 revolutions per minute for a period of 2 minutes the product separated into two components. It was found that the volume of the organic component was approximately 2.7% of the total volume.

Products containing organic components and hydrocarbons appeared in the reactor boiler and separator owing to the generated energy that destroys bonds in CO₂ and H₂O molecules. Synthesis of organic synthesis products occurs according to the radical chain mechanism in reactions 5, 7, 13, 14, 15, 16 and 17. These processes come under the patent being applied for

See Table 1-Overview of Physico-chemical Reactions for details of all the reactions.

### Example 12

Generation of Thermal Energy in 3GTL Processes with Efficiency >1

Type of process: both recycling and single-run.

Data from examples 9 and 10 are used to demonstrate the effect of the generation of thermal energy with an energy efficiency coefficient greater than 1. The example shows energy efficiency at minimum input energies. Type of process: nitrogen in one run; see example 9.

### Process Energy.

Electricity consumption when rapeseed oil was being heated in the process was recorded. Taking into account the heater's efficiency, the energy that was transferred to the rapeseed oil and transport gas-nitrogen—in the space of reactor R1 was calculated. The kinetic energy of the gas and nitrogen stream was factored in. Other forms of energy were not involved in the process. The process's instantaneous and total input energy was calculated.

The flow energy at the outlet from reactor R1 was measured by calorimetry at water cooler E3.

Temperature scanners installed at the water cooler inlet and outlet sent data to the computer for calculating the temperature difference in the coolant in cooler E3. A mass flow meter on the coolant feed pipe sends data to the computer on the current mass flow of coolant. The process's instantaneous and total output energy were calculated.

| Se- | | Unit of | |
|---|---|---|---|
| quence | Parameter name | measurement | Value |
| 1 | Process start time | hour:min. | 3:45 |
| 2 | Process end time | hour:min. | 5:15 |
| 3 | Process duration | hours | 1.50 |
| 4 | Total quantity of energy input | kW | 5.23 |
| 5 | Total quantity of energy output | kW | 7.37 |
| 6 | Average input energy consumption | kW/h | 3.48 |
| 7 | Average value of allocated output energy | kW/h | 4.91 |
| 8 | Process energy efficiency | — | 1.41 |

| | |
|---|---|
| Unit of measurement | Value |

Fed in

| | | |
|---|---|---|
| Methane | kg/h | 0.183 |
| Air | kg/h | 0.287 |
| Total | kg/h | 0.469 |

Obtained

| | | |
|---|---|---|
| Liquid hydrocarbon C26H54 | kg/h | 0.368 |
| Oxygen | kg/h | 0.020 |
| Hydrogen | kg/h | 0.050 |
| Carbon (graphite, fullerene) | kg/h | 0.032 |
| Total | kg/h | 0.470 |

### Operation of the Apparatus as Part of Technological Plant

FIG. 4 shows a general flow chart for executing the declared method according to the invention. The flow chart contains the apparatus of reactor R1, in which the gas and liquid molecules decomposition process is generated and maintained to create streams of electrons that affect the gas and liquid atoms. Electrons binding atoms are released during the decomposition of molecules. These electrons start to interact with atoms and other fragments and during the process they generate thermal energy accumulated in the original gas and liquid molecules. The mechanism for creating plasma as a state of ionizing fragment matter in this apparatus involves a temperature increase, molecules impacting and electric discharges. In consequence of these processes, thermal and electromagnetic energy is generated in the reactions. This energy is used to synthesize new chemical compounds.

The apparatus can be used to destroy molecules of all gaseous and liquid chemical compounds and subsequently synthesize organic synthesis products, fuel hydrocarbons and obtain thermal energy.

Suitable input gases for this method forming the subject of the patent application are:
air;
nitrogen;
carbon monoxide;
carbon dioxide;
oxygen;
hydrogen;
hydrocarbon gases, associated petroleum gases;
inert gases;
nitrogen oxide and nitrogen dioxide;
or mixtures of the above.

Suitable input liquids for this method forming the subject of the patent application are:
liquids containing the elements, C, H O, N;
vegetable oils;
mineral oils;
esters;
crude oil;
mazut;
gas oil;
diesel;
pyrolysis products;
methyl esters (FAME);
paraffin;
gasoline;
alcohol;
water;
or mixtures of the above.
   Operation of the Apparatus with a Mixture (Methane and Air), (Associated Petroleum Gas and Air)-FIG. 4

A gaseous mixture of methane and air (associated petroleum gas and air) with a methane concentration of at least 18% by volume and other methane homologues that ensure a non-explosive concentration with air-stream S1-enters the suction pipe of compressor C1. The reaction gas, purged of molecular hydrogen, is simultaneously fed into the suction pipe of this compressor C1-recycled stream S20. Mixed stream S2 enters inlet E1 of the heater. The gas mixture is heated to a temperature of 150° C. to 160° C. and enters pipe 1 as stream S3 and then enters the acceleration module 2; it leaves internal space 3 of the reactor via deceleration module 4 to reduced pressure zone 5. Reduced pressure zone 5 is created by compressor C2. In deceleration module 4, the gas stream's collision with electrodes 4a and 4b causes a standing pressure wave and tribostatic electricity, dissociation and partial ionization of nitrogen and oxygen molecules and also geometric restructuring of bonds in part of the oxygen and nitrogen atoms. These process are exothermic. In consequence of the released energy, C—H and C—C bonds are broken down, and the subsequent synthesis of hydrocarbons takes place according to the following reactions:

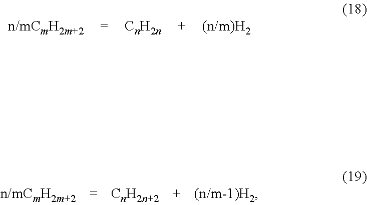

Energy required for synthesis of gasoline components C₅ to C₁₀ from methane and its gas homologues:
Minimum for synthesis of C₅ is 42.696 KJ/mol; maximum for C₁₀ is 339 KJ/mol.
Energy required for synthesis of fuel components C to C₁₈ from methane and its gas homologues:
Minimum for synthesis of C₈ is 263.718 KJ/mol; maximum for C₁₈ is 640.458 KJ/mol. Energy required for synthesis of diesel components C₁₁ to C₂₀ from methane and its gas homologues:

Minimum for synthesis of C₁₁ is 376.74 KJ/mol; maximum for C₂₀ is 715.806 KJ/mol.

The reaction products (gas, liquid, solids in the form of carbon), stream S4, which contain primarily liquid hydrocarbons, are organic components containing oxygen; they release thermal energy in heat exchanger E3. The heat carrier, stream S22-a low-boiling liquid (freon etc.)—is heated in heat exchanger E3, stream S23, and enters the organic Rankine cycle module to generate electricity from heat. Cooled stream S5 enters three-phase separator Mem1-F1. In the separator stream S5 is separated into:
stream S7-solid carbonaceous substance (fullerene);
stream S10-liquid, reaction water;
stream S9-mixture of hydrocarbons and organic liquids;
stream S8-reaction gases.

Gas stream S8 from three-phase separator F1 enters the inlet of compressor C2. Compressor C2 has two functions in this configuration:
1. Creating a reduced pressure zone in the space of reactor R1.
2. Delivering reaction gases, stream S17, into the membrane separation module.

Stream S17 is directed to membrane Mem3. The gas separation occurs on the membrane. Its main target function is to reduce the concentration of molecular hydrogen in the reaction gas, stream S19, to a level that reduces pressure in the apparatus so that more gas can be fed in. Stream S18 is the obtained molecular hydrogen and other gases whose main component is molecular hydrogen. From valve block SP2 stream S20-recycled stream—is directed to the inlet to compressor C1 and then into reactor R1 for further processing. Excess gas, stream S21, is channelled out of the unit for external use. When liquid hydrocarbon products are being processed, it is envisaged that these products will be supplied from external sources into tank F2, stream S15. The hydrocarbons go from tank F2 to the inlet to pump P1, stream S16. The mixture of hydrocarbons and organic liquid, stream S9, and reaction water, stream S10, are also directed to the inlet to pump P1. As stream S11, the mixture of these components enters valve block SP1, where it is split into two streams:
stream S12, which enters the inlet of heater E2. The hydrocarbon mixture heated to a temperature of 150° C. to 160° C. enters the internal space of reactor R1;
stream S14-hydrocarbon mixture discharged out of the unit.
   Operation of the Apparatus with a Mixture of CO₂ and Air-FIG. 4

A gaseous mixture, stream 1, of carbon dioxide and air (flue gas from industrial electricity and heat generating plants can be used) enters the suction pipe of compressor C1. The gas mixture is compressed by compressor C1 to a pressure of 11 to 15 bar and enters heater E1. The CO₂ and air mixture heated to a temperature of 150-160° C. and enters pipe 1 as stream S3 and then enters the acceleration module 2; it leaves internal space 3 of the reactor via deceleration module 4 to reduced pressure zone 5. In deceleration module 4, the gas stream's collision with electrodes 4a and 4b causes a standing pressure wave and tribostatic electricity, dissociation and partial ionization of nitrogen and oxygen molecules and also geometric restructuring of bonds in part of the oxygen and nitrogen atoms. These processes are exothermic; in consequence of the released energy the CO₂ molecules dissociation process occurs according to reaction (24).

730 kJ is required for the complete dissociation of 1 mole of CO₂. The external physical effect corresponds to 8 to 9 KJ/mol of incoming gas, which leads to the creation of a standing pressure wave and the efflux of the gas at supersonic speed and the generation of energy equivalent to 800 to 900 KJ/mol. This energy works on the bonds in carbon dioxide molecules, breaking them down, and leads to reactions 1 to 27; Table 1.

Controlling the energy that occurs when bonds are broken down and input gas molecules dissociate makes it possible to produce generator gas composed primarily of carbon monoxide, oxygen and a small quantity of hydrocarbon gases.

The reaction products (gas, liquid, solids in the form of carbon), stream S4, which contain primarily nitrogen and oxygen, release thermal energy in heat exchanger E3. The heat carrier, stream S22, a low-boiling liquid (freon) heats up in heat exchanger E3, and stream 23 enters the organic Rankine cycle module to generate electricity and heat. The cooled stream S5 is directed into centrifuge Mem1 and three-phase separator F1. There the reaction gases are separated, with the main aim being to separate the nitrogen and oxygen mixture from the residual CO₂ from the reaction gases.

Gas stream S8 from three-phase separator F1 enters the inlet of compressor C2. Compressor C2 has two functions in this configuration:
creating a reduced pressure zone in the space of reactor R1;
delivering the reaction gases, stream S17 to membrane Mem3.

Stream S17 is directed to membrane Mem3. The gas separation occurs on the membrane. Its main target function is to reduce the concentration of molecular nitrogen and oxygen in the reaction gas, stream S19, to a level that reduces pressure in the apparatus so that more gas can be fed in. Stream S18 is the obtained mixture, whose main components are molecular nitrogen and oxygen.

From valve block SP2 stream S20-recycled stream—is directed to the inlet to compressor C1 and then into reactor R1 for further processing. The remainder of the gas, stream S21, is channelled out of the unit for external use.

This configuration does not use the following fixtures:
pump P1;
tank F2;
heater E2;
valve block SP1;
and streams S9, S10, S11, S12, S13, S14;

### EQUIVALENTS

The described examples of the method are limited to the specific implementation possibilities described in this application. Various changes and modifications can be done without any deviation from the scope of the submitted invention.

Functionally equivalent methods and compounds falling within the scope of the submitted patent, along with the methods listed below, are evident from the previous descriptions. These changes and modifications fall within the scope of the formulae contained in this document. The submitted invention is limited solely by the points of the formulae contained in this document and the full scope of equivalents referred to in these formulae. It should be kept in mind that this invention is not limited to particular methods, reagents and compositions of compounds, which can of course be changed. It should also be kept in mind that the terminology used in this application is intended solely to describe the specific implementation methods, but is on no account restrictive. If we describe the features and aspects of this invention using Markush structures, this invention is also described from the perspective of any individual element or sub-group of elements of Markush structures.

For all purposes (and in particular for the written description presented in this invention), all the intervals published in the invention description also cover all possible parts of these intervals and combinations of parts of intervals. Each of these intervals is easily recognisable as sufficiently descriptive and distinctive, even if it is divided into halves, thirds, quarters, fifths, tenths etc. As an example, the interval of 30 to 400 m/s published in this application can be divided into thirds, which can be further divided and combined in any way.

All expressions such as “up to”, “less than”, “more than”, “at least” etc. designate the said quantity, which may subsequently be divided into parts similarly to the intervals described above.

The range comprises every individual element. Even though certain implementation versions are described in this invention description, it should be kept in mind that changes and modifications may be done without deviation from the proposed method on the conditions that are specified in the formulae and text paragraphs of the submitted invention.

### Industrial Application of the Invention

The invention can be used in many branches of industry. It is mainly used for the processing of existing gases and the production of new gases. It can be used for the exploitation of gases produced during combustion processes, the production of organic synthesis products or, for example, the production of “green” hydrogen.

### Legend

1 Feed pipe
2 Acceleration module
2.1 Membrane equivalente
2a Hypersonic tube tubing
2b High-pressure receiving chamber
2c Laval nozzle (hypersonic jet)
2d Beam arrangement of nozzles
3 Internal space of the reactor
4 Deceleration module
4a, 4b Electrodes (tribostatic generator)
5 Reduced pressure zone with reduced atmosphere
6 Output pipe
C1 compressor
C2 gas ventilator (blower)
S1 gas stream
S2 mixed stream
S3 heated mixed stream
S4 stream for reaction products
S5 cooled stream
S7 solid carbonaceous substance stream
S8 reaction gases stream
S9 mixture of hydrocarbons and organic liquids
S10 reaction water liquid stream
S11 synthesized liquid product stream
S12 stream of part of the synthesized product for recycling into the reactor
S13 heated stream of part of the synthesized product for recycling into the reactor
S14 stream of synthesized liquid product out of the apparatus
S15 stream of external input liquid product to equalization tank F2
S16 stream of external input liquid product to inlet of pump P1
S17 stream of reaction gases in continuation phase
S18 stream of nitrogen separated from reaction gases; for external use
S19 stream of reaction gas purged of nitrogen
S20 recycled stream
S21 stream of hydrogen synthesized in the process and residue of methane after membrane separation
S22 low-boiling liquid stream
S23 stream for generating electricity
SP1 valve block splitting the mixture of synthesized product and external input materials into two streams:
   for external use
   for use in recycling
SP2 valve block splitting the mixture of reaction gases into two streams:
   for external use
   for use in recycling
P1 pump for pumping off synthesized liquid product:
   for external use
   for further processing in recycling
E1 input gases heater
E2 heater of liquid products in recycling
E3 heat exchanger
F1 three-phase separator
F2 equalization tank for receiving external input liquids
Mem1 centrifuge for separating solids from a reaction
Mem3 membrane for gas separation
R1 reactor

1. The method is for homolytic and heterolytic cleavage in molecules of gases and liquids with the release of bonding energy and its use to change the internal geometric architecture of some molecules, leading to the synthesis of new chemical compounds that are not contained in the initial gases and liquids, with the secondary release of energy during the synthesis process, without carrying out nuclear reactions on equipment for its realization, characterised by an increase in the energy of the work environment and use of this energy to generate thermal energy with simultaneous synthesis of new chemical compounds, in consequence of the physical effect of a standing pressure wave on the gas and liquid molecules at various temperatures, where the temperature is a measure of activation energy, and subsequent dissociation of the molecules into atoms or fragments of molecules (radicals), partial ionization of atoms and subsequent transformation of the bonds in atoms of the molecules with no change to atomic number but with a change to atomic mass and in the proton-neutron ratio. The method also consists in the direct conversion of neutron mass into the mass equivalent to the total mass of 1 electron and 1 proton that do not go beyond the framework of the electrodynamic interaction of electrons and the nucleus, which ensures the absence of radiation, where the method also consists in the transformation of an atom into a chemical molecule or the reverse transformation of 1 electron and 1 proton into 1 neutron from the volume, where these elementary particles can be free, with external exchange of energy and mass equalling the mass with a positive charge and equal to the reduction in the mass of the neutron and proton. The method furthermore consists in a back reaction to the physical effect consisting in the formation of new chemical compounds that are not contained in the initial gases and liquids, with the release of the energy produced during the process of recombination of atoms into the original molecules, where the execution of the proposed method takes place through a combination of initial influences, such as for example: 12 C 1 H 4=16 Ne=16 O, while the method further consists in rearranging the architecture of some molecules without changing the atomic number, mass number, atomic weight as a reaction to a physical impact, during which new chemical compounds are synthesized, including those that they are not contained in the initial gases and liquids, while the energy generated during these synthesis reactions is released, for example 14 N 2=12 C 16 O; 12 C 16 O 2=14 N 2 16 O. The proposed method is implemented by a combination of initial influences, such as:
increase in temperature of up to 250° C., ideally 140° C. to 150° C.;
reduction in pressure (creation of a reduced atmosphere) to-100 kPa, ideally-65 kPa;
generation of standing pressure waves;
electric discharge (tribostatic discharge, barrier, spark) with a breakdown voltage of 1 to 15 kV;
the value of the magnetic field in the reactor based on the discharge in the gas is 70 to 120 nTl;
micro-explosions;
impact, impact force, at which negative acceleration at from 50,000 to 150,000 g occurs;
or a combination of these influences.

2. A method according to claim 1, characterised by the use of the energy from breakdown-recombination of bonds in the original molecules for transformation of gases and liquids, for subsequent ionization of the molecules' atoms and organisation of a stream of cold plasma that changes the geometric length and angle structure in atoms of the molecules of the original input material within the framework of electrodynamic interaction with adjacent molecules, with the simultaneous formation of new chemical elements/compounds, including those not contained in the initial gases and liquids and two-way exchange of reaction volume of energy-mass, mass-energy, without nuclear reactions taking place.

3. A method according to claim 1, characterised by the fact that the physical impact of the process on nitrogen N₂ molecules, depending on the pressure and speed of the gaseous mixture, launches processes of physico-chemical changes in a molecule of nitrogen as follows:
with symmetrical decomposition of the nitrogen molecule:
into two atoms of nitrogen N, and;
into two CH₂ radicals, or;
one CH₂ radical and an atom of hydrogen H₂ and an atom of carbon C, or;
two atoms of carbon 2C and four atoms of hydrogen 4H, or;
an atom of carbon C and a molecule of methane CH₄;
with asymmetric decomposition of the nitrogen molecule:
into an atom of oxygen O and an atom of carbon C, and;
into a molecule of carbon monoxide CO in a reaction between the atom of carbon C and the atom of oxygen O, or;
in parallel processes of symmetrical and asymmetrical decomposition:
into a molecule of water H₂O and an atom of carbon C, in a reaction between molecular nitrogen N₂ and molecular oxygen O₂, and;
into a molecule of water CH₄ and an atom of carbon C, in a reaction between molecular nitrogen N₂ and molecular oxygen O₂, and;
into a molecule of oxygen O₂ in a reaction between two atoms of oxygen O and;
into a molecule of CO₂ in a combustion reaction between carbon C and molecular oxygen O₂ and into a molecule of CO₂ and a molecule of water H₂O in a reaction between methane CH₄ and two molecules of molecular oxygen O₂, and;
into molecules of organic molecules and hydrocarbons in polycondensation reactions and synthesis of the following products:
Aldehydes;
Ketones;
Alcohol;
Simple and complex ethers;
Fatty acids;
Alcohols of fatty acids;
Hydrocarbon gases;
Hydrocarbon liquids:
Naphthenes;
Aromatics;
Iso-alkanes;
N-alkanes.

4. A method according to claim 1, characterised by the fact that the physical impact of the process on nitrogen O₂ molecules launches processes of physico-chemical changes in a molecule of nitrogen as follows:
with symmetrical decomposition only:
into two atoms of oxygen O, and;
into two atoms of nitrogen N and four atoms of hydrogen, and;
into two CH₂ radicals and two molecules of hydrogen, or;
one CH₂ radical and three molecules of hydrogen H₂ and an atom of carbon C, or;
two atoms of carbon 2C and eight atoms of hydrogen 8H, or;
two molecules of methane CH₄;
with asymmetrical decomposition only:
into a molecule of nitric oxide NO and two atoms of hydrogen, or;
into a molecule of nitrogen and 4 atoms of hydrogen, and;
dva CH₂ radicals and 4 atoms of hydrogen, or;
one CH₂ radical and three molecules of hydrogen H₂ and an atom of carbon C, or;
two atoms of carbon 2C and eight atoms of hydrogen 8H, or;
two molecules of methane CH₄;
in parallel processes of symmetrical and asymmetrical decomposition:
into a molecule of water H₂O and an atom of carbon C, in a reaction between molecular nitrogen N₂ and molecular oxygen O₂, and;
into a molecule of methane CH₄ and an atom of carbon C, in a reaction between molecular nitrogen N₂ and molecular oxygen O₂, and;
into a molecule of nitrogen N₂, in a reaction between two atoms of nitrogen N, and;
into a molecule of CO₂ in a combustion reaction between carbon C and molecular oxygen O₂ and into a molecule of CO₂ and a molecule of water H₂O in a reaction between methane CH₄ and two molecules of molecular oxygen O₂, and;
into a molecule of organic molecules and hydrocarbons in polycondensation reactions and synthesis of the following products:
Aldehydes;
Ketones;
Alcohol;
Simple and complex ethers;
Fatty acids;
Alcohols of fatty acids;
Hydrocarbon gases;
Hydrocarbon liquids:
Naphthenes;
Aromatics;
Iso-alkanes;
N-alkanes.

5. A method according to claim 1, characterised by the fact that the physical impact of the process on methane CH₄ molecules launches processes of physico-chemical changes in a molecule of methane as follows:

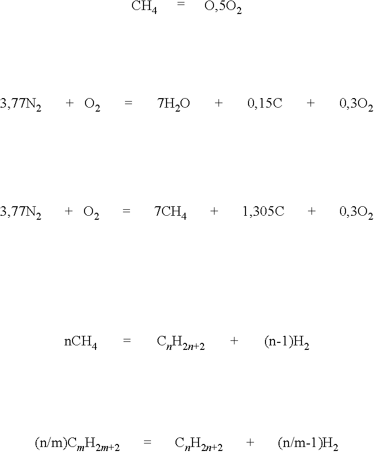

6. A method according to claim 1, characterised by the fact that the physical impact of the process on carbon dioxide CO₂ molecules launches processes of physico-chemical changes in a molecule of carbon dioxide CO₂ as follows:
possible decomposition of 2CO₂=2CO+O₂;
possible decomposition of CO₂=C+O₂;
possible decomposition of CO₂=N₂₀;
possible decomposition of 2N₂₀₌₂N₂+O₂;
The following reverse reactions are possible:

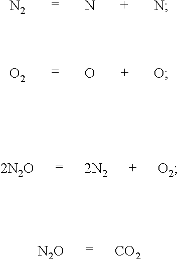

7. A method according to claim 1 characterised by the fact that the specific plasma energy is 0.01 J/cm³ to 16 J/cm³.

8. A method according to claim 1 characterised by the fact that the intensity of the electric field in the reactor based on a discharge in gas is less than 14 kV/cm.

9. A method according to claim 1 characterised by the fact that the gas component is composed of methane, ethane, propane, butane or a mixture of at least two of these gases with an admixture of CO₂, air or oxygen.

10. A method according to claim 1 characterised by the fact that the gas component is composed of ethylene, propylene, butylene, isobutene or a mixture of at least two of these gases with an admixture of CO₂, air or oxygen.

11. A method according to claim 1 characterised by the fact that the gas component is composed of methane, ethane, propane, isopropane, butane, isobutene, etFC-butane or a mixture of at least two of these gases with an admixture of CO₂, air or oxygen.

12. A method according to claim 1 characterised by the fact that the gas component is composed of CO₂.

13. A method according to claim 1 characterised by the fact that the gas component is composed of N₂.

14. A method according to claim 1 characterised by the fact that the gas component is composed of a mixture of oxides of nitrogen.

15. A method according to claim 1 characterised by the fact that the gas component is composed of an inert gases component or a mixture of at least two of them.

16. A method according to claim 1 characterised by the fact that the gas component is composed of a mixture of N₂, CO₂, O₂.

17. A method according to claim 1 characterised by the fact that the gas component is composed of air.

18. A method according to claim 1 characterised by the fact that the liquid component contains gasoline fractions, paraffin fractions, diesel fractions, oil fractions, mazut, diesel or a mixture of at least two of these substances.

19. A method according to claim 1 characterised by the fact that the liquid component contains vegetable oils, mineral oils or a mixture of at least two of these substances.

20. A method according to claim 1 characterised by the fact that the liquid component contains heat-treated vegetable oils, mineral oils or a mixture of at least two of these substances.

21. A method according to claim 1 characterised by the fact that the liquid component contains water.

22. A method according to claim 1 characterised by the fact that the liquid component contains free fatty acids, alcohols, aldehydes, ketones, ether and ethers, unsaturated hydrocarbons or a mixture of at least two of these substances.

23. A method according to claim 1 characterised by the fact that the following are obtained with the help of the fed-in liquid:
inorganic, organic, hydrocarbon liquids or a mixture thereof with an altered composition;
non-hydrocarbon, hydrocarbon gases or a mixture thereof with an altered composition;
thermal energy whose value provides an energy efficiency coefficient greater than 1.

24. The apparatus for carrying out the method according to claim 1, where physical action is used:
shock waves and a set of devices that cause this wave in the reactor and that heat the gas to the required temperature. an electric discharge that occurs as a result of the tribostatic phenomenon;
consisting of a reactor that contains:
1. Acceleration module (2), which consists of a high-pressure chamber (2b) and a membrane equivalent (2.1), which is a set of Laval micro-nozzles (2c), to ensure a delay in the pressure rise in the low-pressure chamber (3) and a maximum speed in the critical section nozzles and the maximum speed at the exit of each nozzle.
2. A low-pressure chamber (3) that contains the process gas that is initially in the chamber (3) and whose concentration must be maintained by converting the raw gas into a working gas. The synthesis of liquid products is possible in the low-pressure chamber.
3. The Deceleration module (4), which is a massive device consisting of metal plates (4.1) that block the raw gas flow channel as much as possible and ensure that the raw gas collides with them. The Deceleration module (4) as an internal device contains a tribostatic voltage generator (4.2).
The tribostatic generator (4.2) is a system consisting of insulators attached to the metal plates of the deceleration module (4) and alternating metal electrodes (4a), (4b), between which there is a gap of 0.5 to 10 mm, preferably 1 mm, when the metal electrode conductors are selected according to the following criteria:
Electrodes with the maximum difference in the emission work of electrons from metals must be placed next to each other.
The movement of raw gas through the gap between the electrodes causes a tribostatic effect and the generation of voltage on the adjacent electrodes, and as soon as the breakdown voltage of the gas gap is reached, a discharge occurs in the moving gas, which results in further dissociation of molecules and ionization of atoms in the given gas.
During density increase, the initially cold gas in the reactor is almost immediately heated to a high temperature (up to 30,000 K), which can be controlled by changing the intensity of the shock wave by changing the temperature:
pressure in the high-pressure chamber of the acceleration module;
pressure in the module's low-pressure chamber;
inlet and working gas parameters;
Various processes then take place in the heated gas particle:
excitation of molecular vibrations,
dissociation, ionization, etc., the role and speed of which depends on temperature (and density).

25. Apparatus according to claim 24 characterised by the fact that it is fitted with a feed pipe (1) for feeding in gases and an output pipe (6) for its discharging:
inorganic, organic, hydrocarbon liquids or mixtures thereof with modified composition;
non-hydrocarbon, hydrocarbon gases or a mixture thereof with a modified composition;
thermal energy whose value provides an energy efficiency factor greater than 1.

26. A method according to claim 1 characterised by the fact that the level of the liquid component in the reactor is kept close to the acceleration module (2).

27. A method according to claim 1 characterised by the fact that the specific energy of plasma ranges from 0.01 J/cm³ to 16 J/cm³.

28. A method according to claim 1 characterised by the fact that the strength of the tribostatic electric field in the reactor based on the discharge in the gas is lower than 14 kV/com and the tribostatic generator contains the metals Fe, Co, Ni, Cr, Gd, W, Al or alloys thereof containing C, Cu, Hf, Pd, Os, Pt.

29. A method according to claim 1 characterised by the fact that the value of the magnetic field in the reactor based on the discharge in the gas is 70 to 120 nTl.
